(19) United States
(12) Patent Application Publication
(10) Pub. No.: US 2010/0240302 A1
(43) Pub. Date: Sep. 23, 2010

(54) WIRELESS FM REPEATER SYSTEM

(75) Inventors: Robert T. Buczkiewicz, West Bend, WI (US); William R. Steinike, Cedarburg, WI (US)

Correspondence Address: CAESAR, RIVISE, BERNSTEIN,;COHEN & POKOTILOW, LTD., 11TH FLOOR, SEVEN PENN CENTER, 1635 MARKET STREET, PHILADELPHIA, PA, 19103-2212, US

(73) Assignee: L.S. Research, LLC, Cedarburg, WI (US)

(21) Appl. No.: 12/408,389

(22) Filed: Mar. 20, 2009

(51) Int. Cl. H04B 7/15

(52) U.S. Cl. 455/11.1

(57) ABSTRACT

A wireless FM repeater system for converting the audio signal from a portable audio source (e.g., iPod, MP3 player, a cell phone or satellite radio, etc.) and transmitting it to the FM tuner of a vehicle stereo system where access to a hard-wired input jack does not exist. The system includes a transmitter, coupled to the audio source, that transmits the audio source signals at a high frequency (e.g., 902-928 MHz, 2.4-2.483 GHz, 434/868 MHz) to a repeater located adjacent the vehicle's audio system antenna and wherein the repeater downconverts, without demodulation, the high frequency carrier and includes an FM transmitter that transmits the audio source signal, in compliance with government regulations, to the vehicle's audio FM system, via the vehicle's FM antenna, without signal degradation.

### BACKGROUND OF THE INVENTION

1. Field of Invention

The current invention relates to low power transmitters and receivers and more particularly, to a low power transmitter/repeater system for use in a vehicle for transmitting portable audio source outputs to the vehicle's radio system that lacks auxiliary input jacks.

2. Description of Related Art

With the rapid growth in hand-held multi-media devices, especially MP3 players, the desire to integrate these devices with existing vehicle systems has also greatly increased. In particular, attempting to couple audio inputs from these audio sources to most conventional vehicle FM stereo equipment is marginal at best. Most vehicle audio equipment do not even have a provision for supporting the direct coupling with such auxiliary audio devices.

One available solution is the cassette adapter (U.S. Pat. No. 4,734,897 (Schotz)) developed by L.S. Research, Inc. (now L.S. Research, LLC, the assignee of the present application). The cassette adapter provides the ability to couple the audio signal from an audio device to the car audio system utilizing the cassette player. (e.g, RCA car cassette adapter, part number rcaah600; Monster iCarPlay™ cassette adapter for iPod® and iPhone™). Although very successful, this product is now reaching its end of life due to the fact that cassette players have now been replaced by CD players in most vehicles built after 2000. The future trend is for car manufacturers to include an audio input jack in the audio system to allow a hard-wired or direct connection of the MP3 player. Consequently, an interim solution is needed for the majority of the vehicles on the road today that have neither a cassette player or an audio input jack. For these vehicles, the only method of coupling is via the FM car radio.

Another solution, available since 2003, is the use of low power FM stereo transmitters to broadcast a signal from an audio device to a standard FM car radio. Companies such as Belkin, Griffin and DLO have developed low power FM stereo transmitters to broadcast a signal from an audio device to a standard FM car radio. (e.g., Belkin F8V7101 TuneCast Auto FM transmitter; Griffin Technology FM transmitter and auto charger 4031-RDGC). This allows the program content of the audio device to be played over the vehicle sound system. Conceptually, this device, when connected to an audio input device such as a MP3 player forms a low power FM radio station. If the user tunes both the FM transmitter and his car radio to a frequency that is unused by commercial broadcast stations, it becomes possible to receive the signal transmitted by the FM transmitter and play the audio over the vehicle sound system.

However, there are limitations to such devices. In order to reduce the potential for interference with commercial FM broadcasts, the FCC restricts the radiated power of all non-commercial FM transmitters to a very low level. (See Appendix for pertinent FCC regulations). A transmitter that is operating at the FCC power limit cannot provide a strong enough signal to the car radio to provide high quality reception. This will always be the primary limitation of all FM transmitters currently on the market. Consequently, it is necessary to locate the FM transmitter very close to the vehicle antenna which is impractical. The FM transmitter needs to be located within arms reach of the vehicles driver's seat to allow the user to control the audio device (e.g., to select songs). Since the majority of cars have their radio antenna located on an outside fender, rooftop or rear window it is not possible to satisfy both requirements and, as a result, the performance will be degraded. In addition, in large metropolitan areas such as New York and Los Angeles, commercial broadcast stations occupy most, if not all, available FM channels. In order to be able to override an existing FM radio station, the FM transmitter needs to provide an even higher signal level to the vehicle antenna. Most of the FM transmitter manufacturers have attempted to resolve these two problems by boosting the power levels of their devices by 10 to 100 times the legal limit. This has been verified by both assignee of the present application, namely, LS Research LLC, and a group affiliated with National Public Radio. The FCC is aware of this and has taken legal action against some of these offenders. Moreover, even with the elevated power levels, the general response from consumers in that the overall performance is still very poor. Reviews (e.g., by Amazon and various FM transmitter web/blog sites) of these types of devices are filled with complaints about their performance.

Thus, there remains a need for a device that allows the use of an FM transmitter that can be placed very close to the vehicle antenna in order to allow maximum signal coupling to the vehicle audio system antenna and provide better overall performance when compared to all other products available on the market. In addition, this device must minimize current consumption and the use of wires. And furthermore, this device must operate within the confines of government regulations, viz., in the U.S., Title 47 CFR Part 15.

All references cited herein are incorporated herein by reference in their entireties.

### BRIEF SUMMARY OF THE INVENTION

A wireless FM repeater system for converting an audio signal from a portable audio source (e.g., iPod®, MP3 player, CD player etc.) and transmitting it to a vehicle's FM tuner having an FM tuner antenna where the FM tuner lacks an input jack for coupling to the portable audio source. The system comprises: a transmitter, coupled to the audio source, for using a first frequency carrier signal (e.g., 902-928 MHz, 2.4-2.483 GHz, 434/868 MHz, etc.) comprising the audio signal to transmit a first transmitted signal, and wherein the transmitter comprises a channel select that permits a user to provide the transmitter with an FM frequency channel setting to which the vehicle's FM tuner is tuned; and a self-powered (e.g., battery, solar cell, etc.) repeater that receives the first transmitted signal and downconverts the first transmitted signal, without demodulating said first transmitted signal, to an FM frequency band carrier signal (e.g., 88-108 MHz), and wherein the repeater transmits the FM frequency band carrier signal to form a second transmitted signal, and wherein the second transmitted signal is transmitted from a repeater antenna and is received by the vehicle's FM tuner antenna.

A method for receiving an audio signal from a portable audio source on a vehicle's FM tuner having an FM tuner antenna wherein the FM tuner lacks an input jack for coupling to the portable audio source (e.g., iPod®, MP3 player, CD player etc.), and wherein the method comprises: inputting to a transmitter an FM frequency channel setting that corresponds to a channel to which the vehicle's FM tuner is tuned; generating a first frequency carrier signal (e.g., 902-928 MHz, 2.4-2.483 GHz, 434/868 MHz, etc.) including the audio signal therein, provided from the audio source to the transmitter, and transmitting the first frequency carrier signal to form a first transmitted signal; receiving, by a self-powered (e.g., battery, solar cell, etc.) repeater, the first transmitted signal and downconverting it, without demodulating it, to an FM frequency band carrier signal (e.g., 88-108 MHz); transmitting, from a repeater antenna, the FM frequency band carrier signal to form a second transmitted signal; and receiving the second transmitted signal by the vehicle's FM tuner antenna.

A wireless FM repeater system for converting an audio signal from a portable audio source (e.g., iPod®, MP3 player, cell phone, CD player etc.) and transmitting it to a vehicle's FM tuner having an FM tuner antenna where the FM tuner lacks an input jack for coupling to the portable audio source. The system comprises: a digital transceiver, coupled to the audio source, for digitizing the audio signal and digitally modulating a first frequency carrier signal (e.g., 902-928 MHz, 2.4-2.483 GHz, 434/868 MHz, etc.) with the digitized audio signal to form continuous digital audio that is streamed over a bidirectional link with a self-powered (e.g., battery, solar cell, etc.) repeater, and wherein the transmitter comprises a channel select that permits a user to provide the transceiver with an FM frequency channel setting to which the vehicle's FM tuner is tuned; and wherein the repeater receives the continuous digital audio and decodes the continuous digital audio, wherein the repeater converts the decoded continuous digital audio into analog audio signals, and wherein the repeater comprises an FM frequency band transmitter which modulates an FM frequency band carrier signal (e.g., 88-108 MHz) with the audio signals to form an FM band transmitted signal that transmitted by a repeater antenna and that is received by the vehicle's FM tuner antenna.

A method for receiving an audio signal from a portable audio source (e.g., iPod®, MP3 player, cell phone, CD player etc.) on a vehicle's FM tuner having an FM tuner antenna wherein the FM tuner lacks an input jack for coupling to the portable audio source. The method comprises: inputting to a digital transceiver an FM frequency channel setting that corresponds to a channel to which the vehicle's FM tuner is tuned; digitizing the audio signal, provided from the audio source, to form a digitized audio signal; digitally modulating a first frequency carrier signal (e.g., 902-928 MHz, 2.4-2.483 GHz, 434/868 MHz, etc.) with the digitized audio signal that is continuously streamed over a bi-directional link with a self-powered (e.g., battery, solar cell, etc.) repeater; receiving the continuously streaming digital audio, by the repeater, and decoding the streaming digital audio into decoded continuous digital audio; converting the decoded continuous digital audio into analog audio signals; modulating an FM frequency band carrier signal (e.g., 88-108 MHz) with the analog audio signals to form an FM frequency band signal that is transmitted from a repeater antenna to the FM tuner antenna.

### BRIEF DESCRIPTION OF SEVERAL VIEWS OF THE DRAWINGS

The invention will be described in conjunction with the following drawings in which like reference numerals designate like elements and wherein:

FIG. 1 is a block diagram of the present invention including a transmitter and a repeater and with an audio input device shown coupled to the transmitter and with the repeater providing a wireless signal in the FM broadcast band to an FM receiver;

FIG. 2 is a block diagram of the transmitter portion of the present invention;

FIG. 2A is block diagram of an alternative transmitter portion of the present invention;

FIG. 3 is a block diagram of the repeater portion of the present invention;

FIG. 4A is an exemplary schematic for the electronics of the transmitter of FIG. 2;

FIG. 4B is an exemplary schematic for the power electronics of the transmitter of FIG. 2;

FIG. 4C is an exemplary schematic for the channel select display of the transmitter of FIG. 2;

FIG. 5A is an exemplary schematic for the electronics of the repeater of FIG. 3;

FIG. 5B is an exemplary schematic for the power electronics of the repeater of FIG. 3;

FIG. 6 is a block diagram of an alternative transmitter/repeater of the present invention for use in the 2.4 GHz frequency band;

FIG. 7 is a block diagram of an alternative transmitter/repeater of the present invention for use in the 434/868 MHz frequency band (e.g., in Europe);

FIG. 8 is a block diagram of a digital audio link transmitter/repeater of the present invention;

FIGS. 9A-9B show the installation of the present invention in a vehicle where there is no input jack for the type of audio devices discussed previously.

FIG. 10 discloses a modified satellite receiver for transmitting its output to the repeater of the present invention;

FIG. 11A depicts a first variation of the repeater antenna coupling with a vehicle window antenna;

FIG. 11B depicts another variation of the repeater antenna for coupling with a mast-type vehicle antenna;

FIG. 11C depicts another variation of the repeater antenna that directly couples with a mast-type vehicle antenna; and

FIG. 11D depicts an environmentally-rugged repeater that directly couples with mast-type vehicle antenna at its base.

### DETAILED DESCRIPTION OF THE INVENTION

As will be discussed in detail later, the invention of the present application involves the use of a transmitter, coupled to the audio source, that wirelessly transmits the audio source signals at a high frequency (e.g., 902-928 MHz, 2.4-2.483 GHz, 434/868 MHz, etc.) to a repeater located adjacent the vehicle's audio system antenna and wherein the repeater downconverts the high frequency carrier and includes an FM transmitter that wirelessly transmits the audio source signal, in compliance with government regulations, to the vehicle's audio system antenna without signal degradation. The invention accomplishes this without the need to demodulate any signals, without the use of wires (other than to couple the audio source to the invention or enhance repeater-vehicle antenna coupling), while minimizing current consumption (e.g., ≦10 mA of current draw on the external power source) and while complying with government regulations. In particular, where the 902-928 MHz carrier signal is used, the transmitter radiated emissions are limited to 50 mV/m at 3 meters which is −12.5 dBm (or 0.75 mW); see Appendix regarding “§15.249 Operation with the bands 902-928 MHz” et al. With regard to the repeater transmitted output in the FM frequency band, the radiated emissions are limited to 250 μVm at 3 meters which is −47.33 dBm (or 18.5 nW); see Appendix regarding “§15.239 Operation in the band 88-108 MHz.”

The term “wireless” as used throughout the Specification means that the primary signals, namely, a first transmitted signal 26 (from a first transmitter 22 to a repeater 24) and a second transmitted signal 28 (from the repeater 24 to the vehicle's FM tuner antenna) are conveyed over the air. Where the repeater 24 uses an external conductor 24E′ that is directly coupled to the vehicle's FM tuner antenna, to enhance the repeater and vehicle FM tuner antenna coupling, such a configuration still comes within the definition of “wireless” since the repeater 24 can still transmit the second transmitted signal 26 to the FM tuner antenna over the air without the direct coupling. Moreover, the term “wireless” as used throughout this Specification also means that there are no power conductors required for the repeater 24.

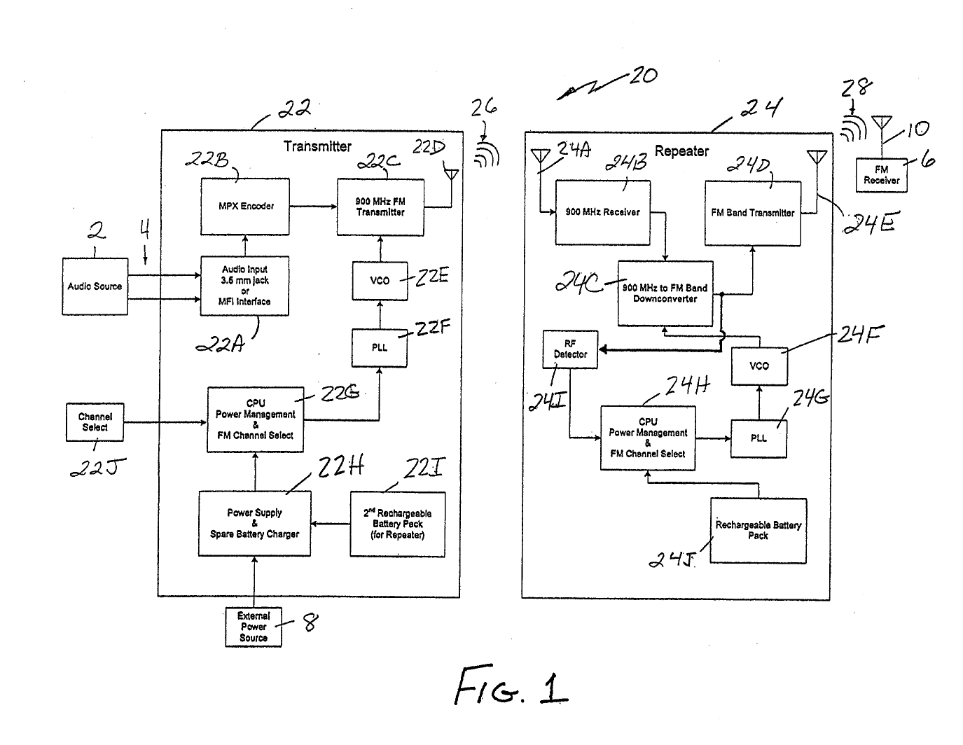

As shown in FIG. 1, the present invention 20 comprises a transmitter 22 and a repeater 24. The transmitter 22 is a device that converts an audio source 2 (e.g., typically a portable audio source such as, but not limited to, MP3 players (e.g., iPod®), portable media players (e.g., a CD player), cellular and smart phones (e.g., iPhone™), personal navigation devices (e.g., GPS device), satellite radio, etc.) output 4 into a high frequency stereo encoded signal 26. The repeater 24 is a device which receives the high frequency stereo encoded signal 26 from the transmitter 22 and downconverts it, without demodulating it, to a signal 28 in the FM broadcast band for receipt by a conventional FM receiver 6. It should be noted that both the encoded signal 26 and the FM broadcast band signal 28 fully comply with government regulations for such transmissions. In particular, the transmitter 22 comprises an audio input 22A (3.5 mm jack or MFI (“made for iPod®”) interface), an MPX (multiplex) encoder 22B, a 900 MHz FM transmitter 22C, an antenna 22D, a voltage-controlled oscillator (VCO) 22E, a phase-locked loop (PLL) 22F, a CPU power management & FM channel select 22F, a power supply & spare battery charger 22H, a second rechargeable battery pack 22I (as back-up for use in the repeater 24) and a channel select 22J. Table 1 (below) sets forth some of the exemplary major components used therein. The repeater 24 comprises a receive antenna 24A, a 900 MHz receiver 24B, a 900 MHz-to-FM band downconverter 24C, an FM band transmitter 24D, a transmit antenna 24E, a VCO 24F, a PLL 24G, a CPU power management & FM channel select 24H, an RF detector 24I and an internal power supply 24J (e.g., a rechargeable battery pack). Table 2 (also below) sets forth some of the exemplary major components used therein.

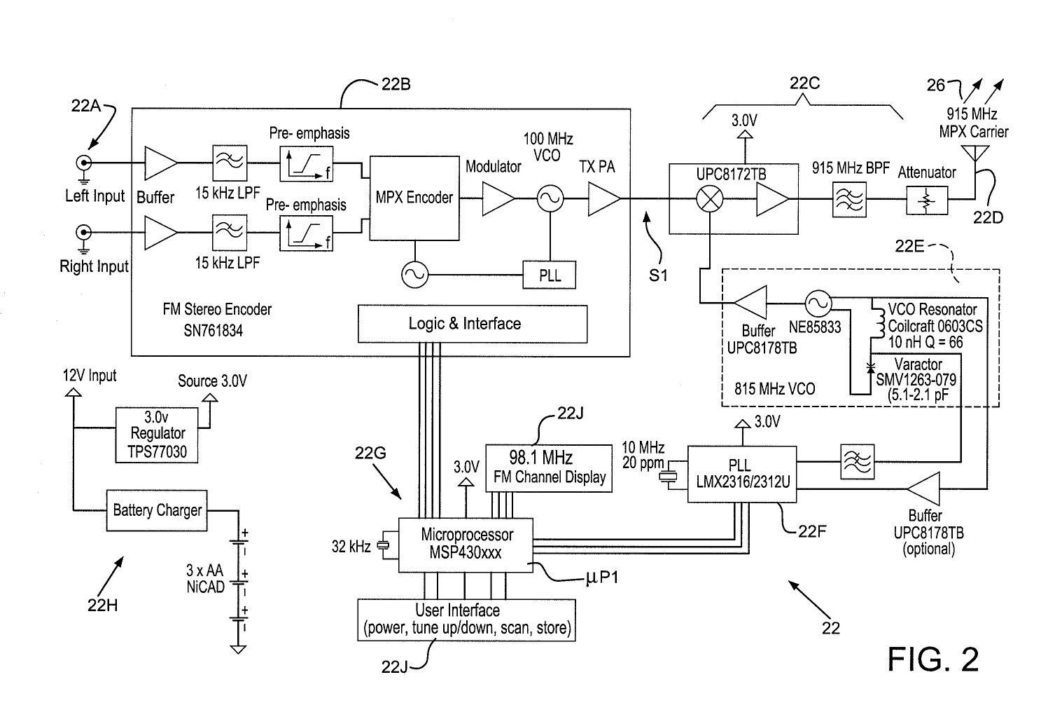

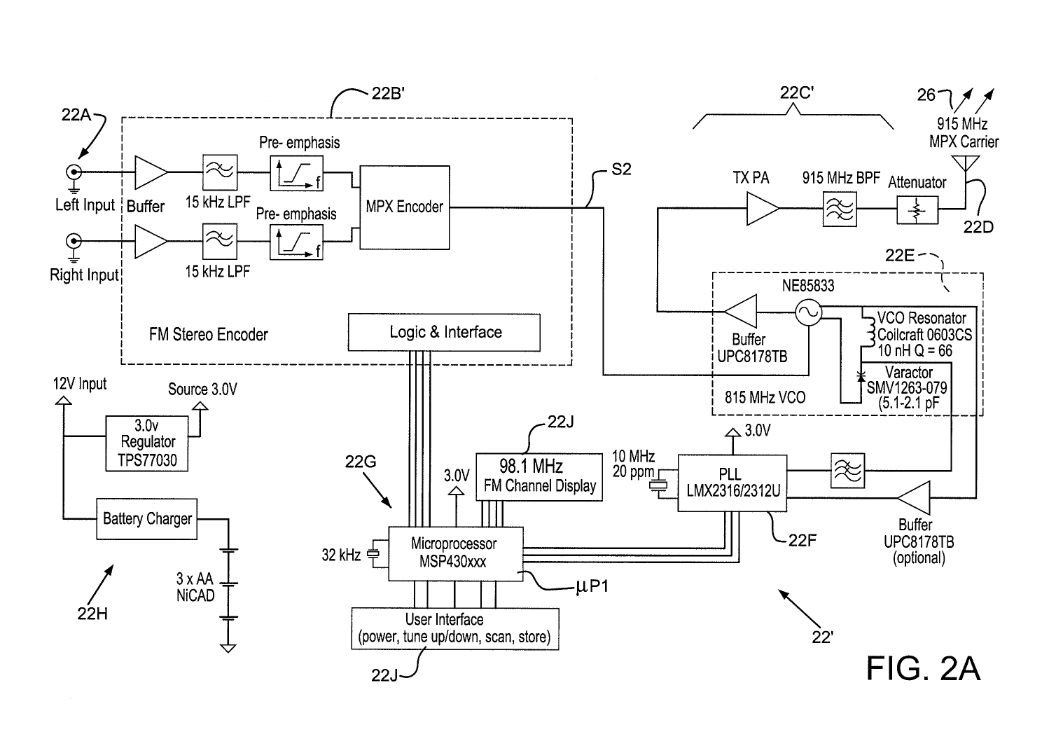

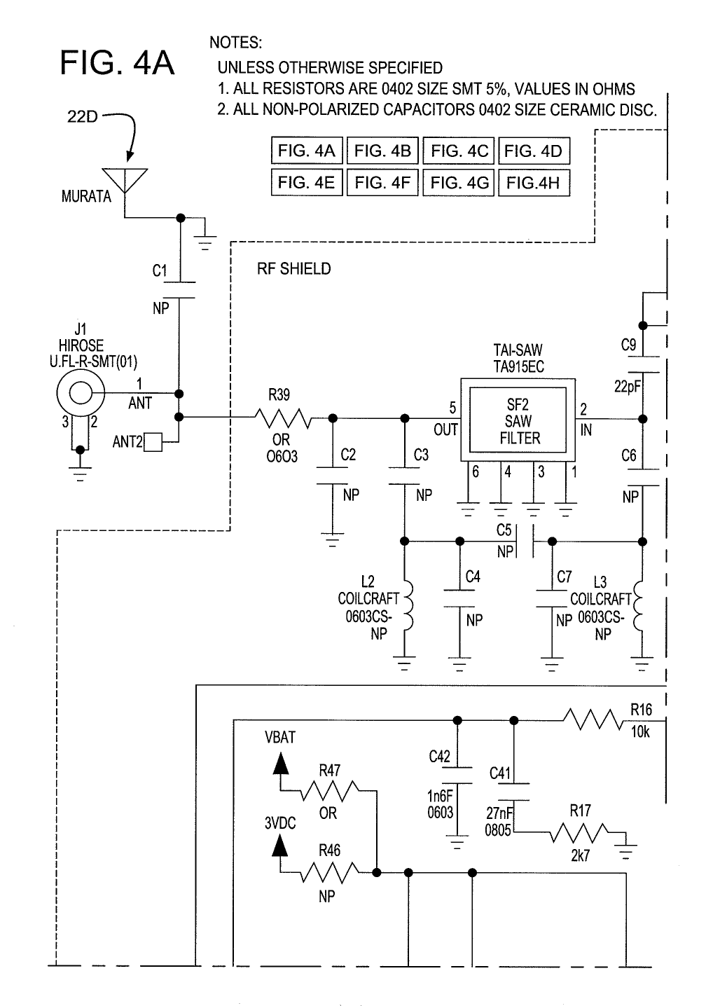

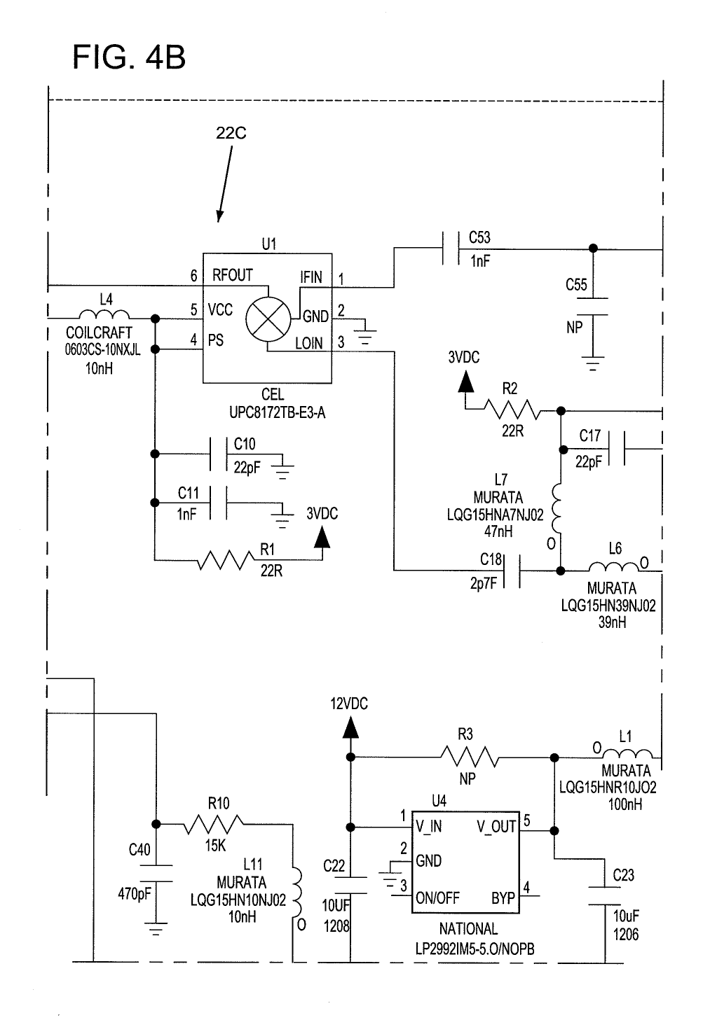

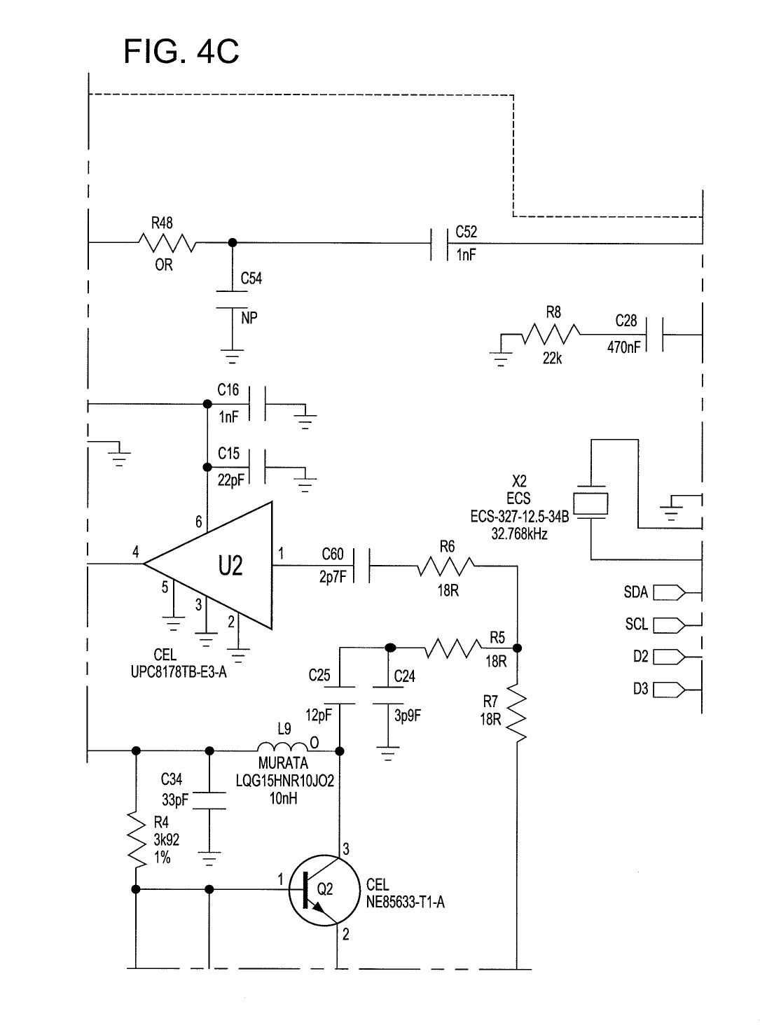

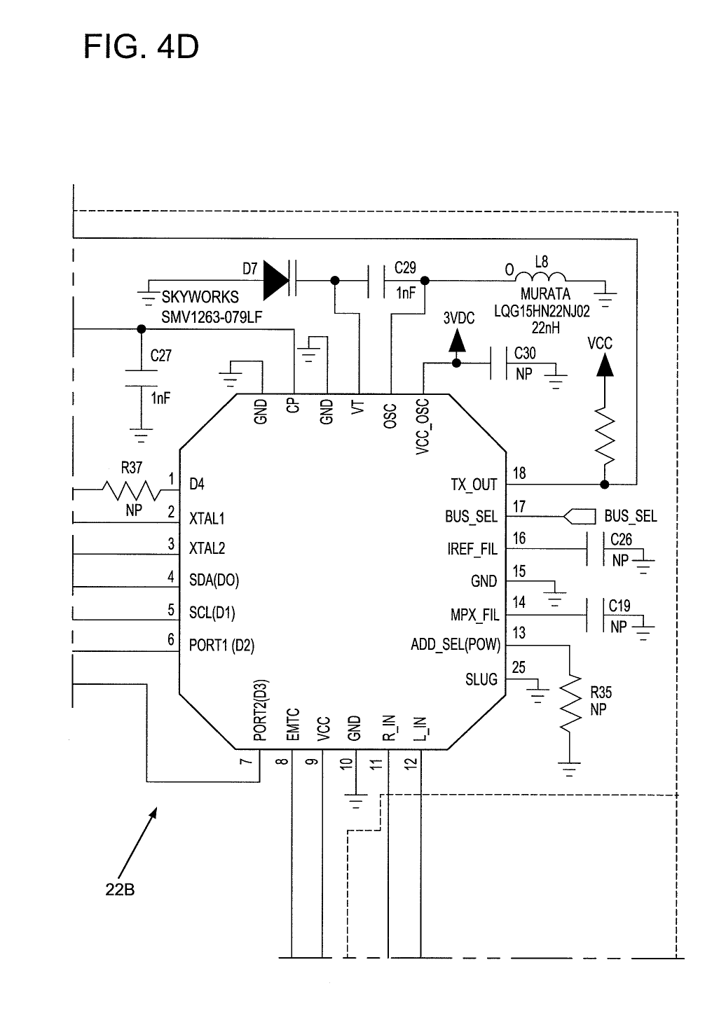

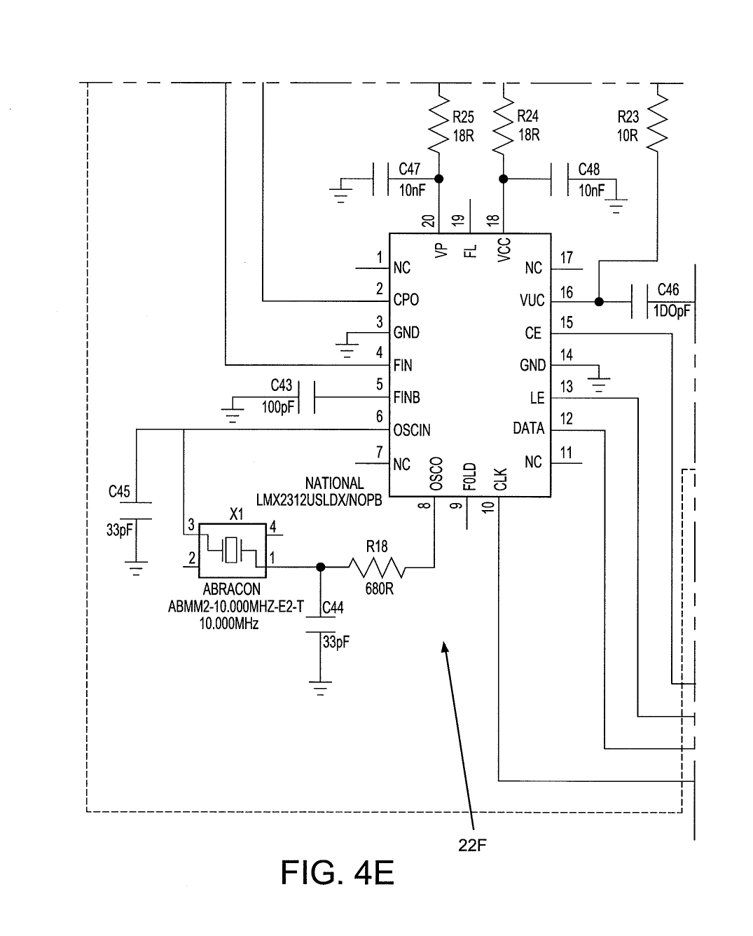

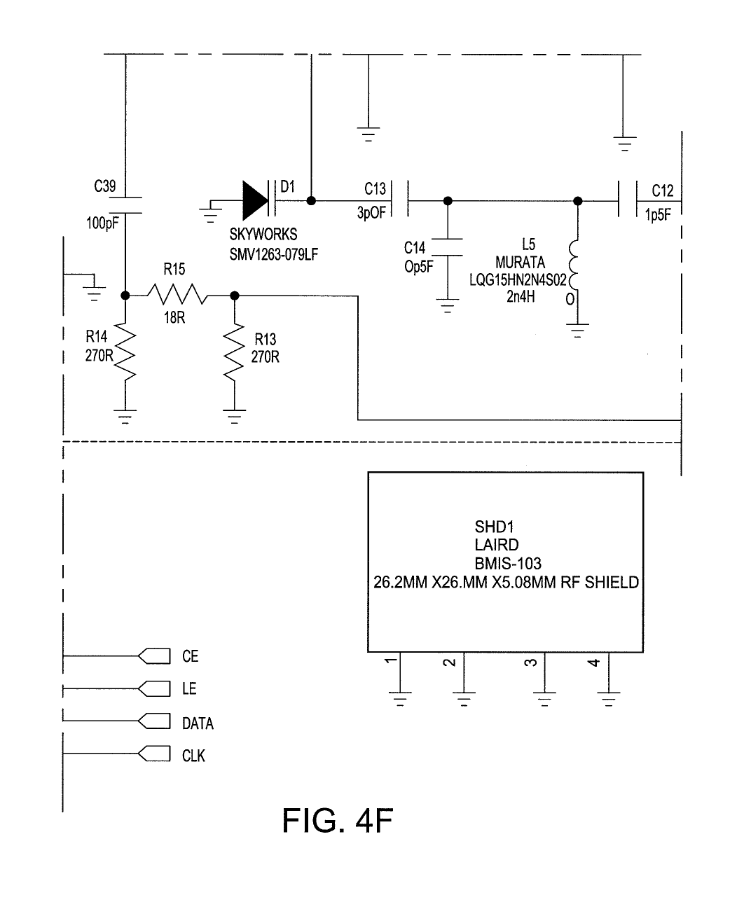

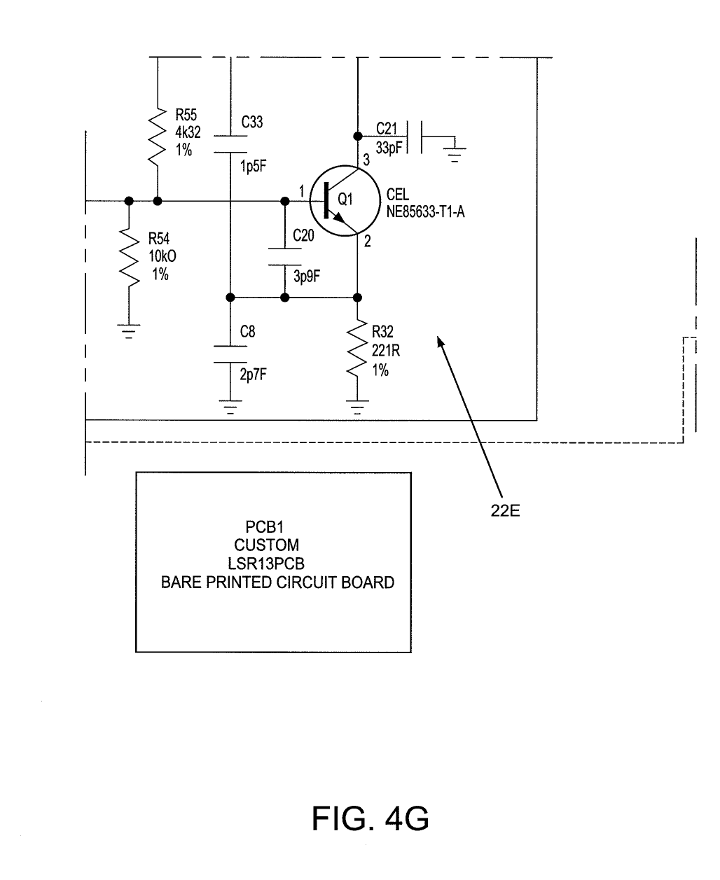

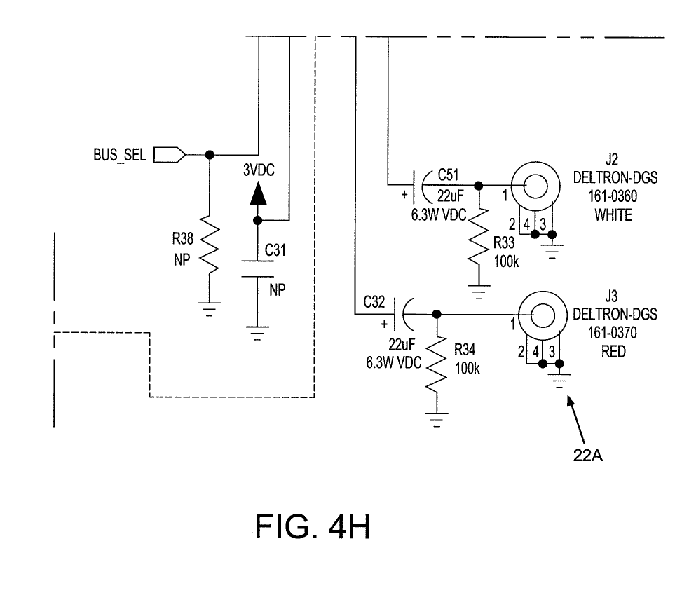

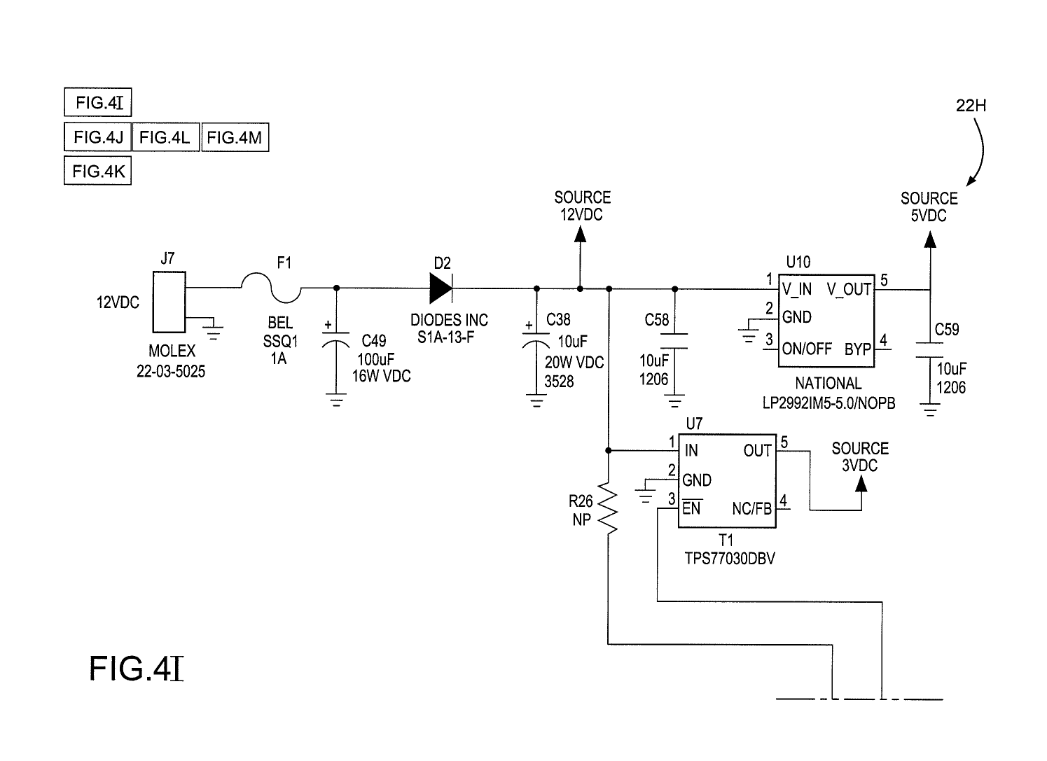

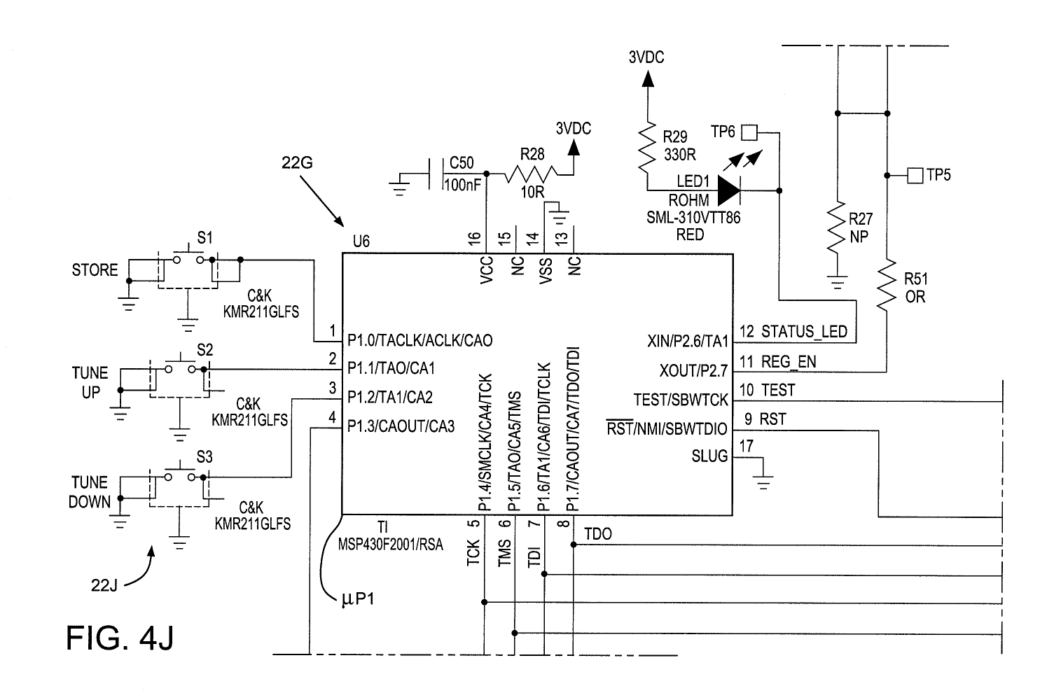

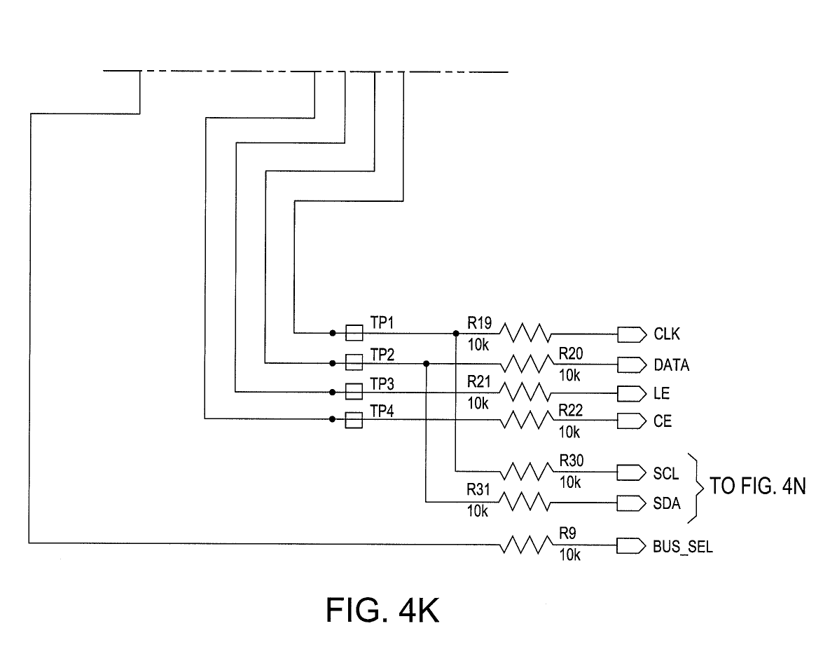

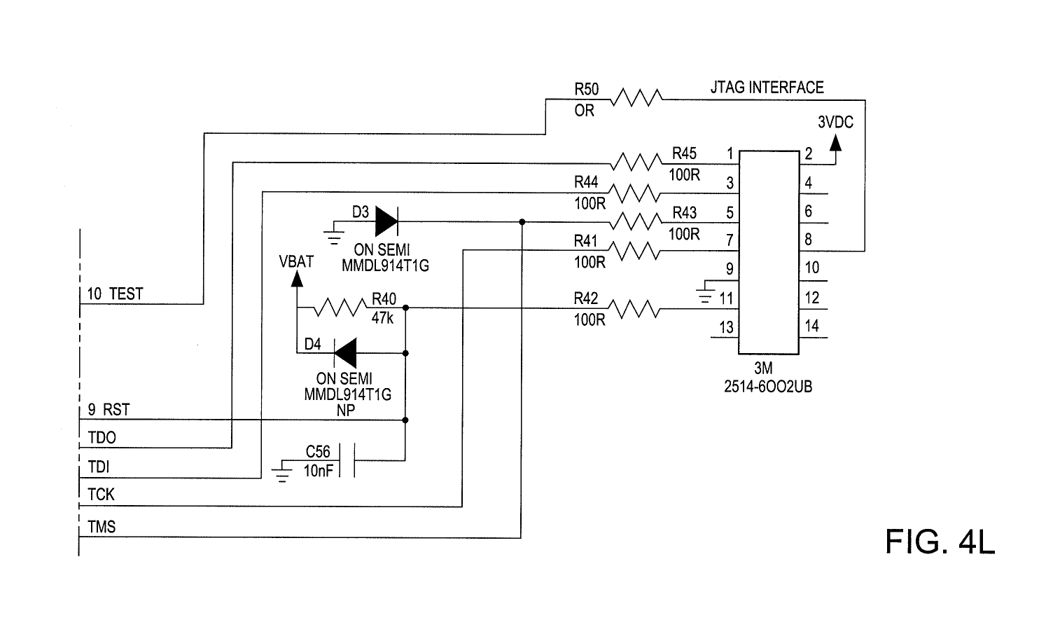

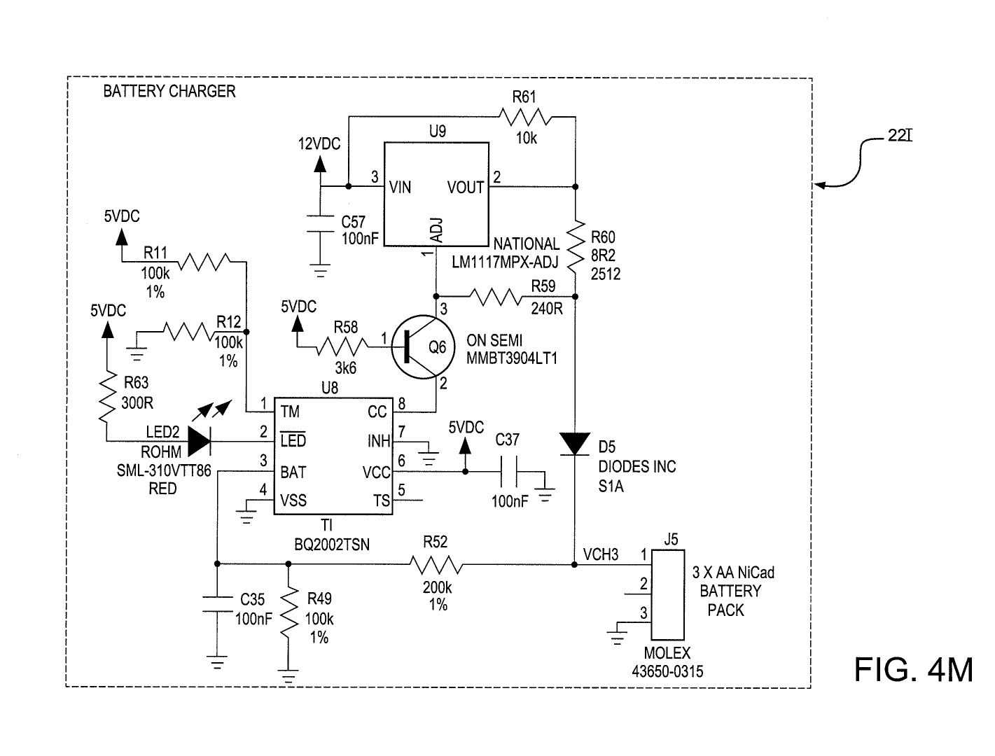

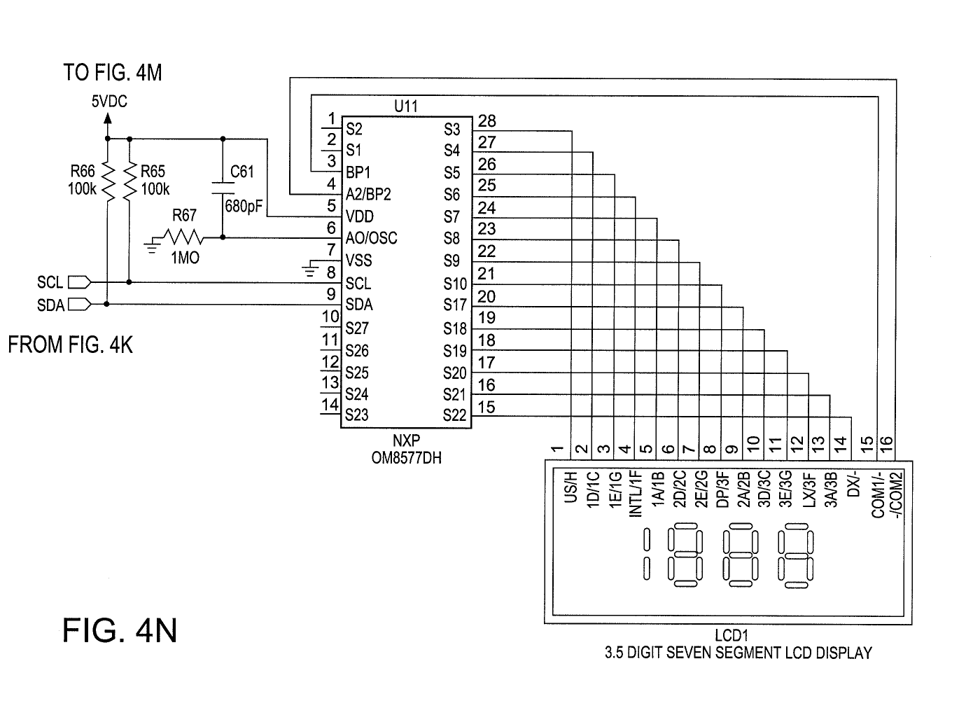

The following discussion of the transmitter 22 utilizes FIG. 2 and the corresponding schematics FIGS. 4A-4C (by way of example only).

Via the audio interface 22A, the audio output signal 4 from any suitable audio device (e.g., MP3 player) is connected to the transmitter 22 via an audio cable with a compatible connector, typically a 3.5 mm headphone plug or other diameter headphone jacks, or even customized connectors (e.g., those made for iPod®/iPhone™ (MFI) connectors (or other connectors) available from Apple. It is within the broadest scope of the present invention to include audio source outputs both in analog or digital format. In order to be compatible with and properly decoded by the vehicle's FM car radio, the right and left channel audio inputs need to be converted to an industry standard stereo multiplex (MPX) signal.

In the multiplex encoder 22B, an FM stereo radio with a transmitter IC such as the TI SN76133 is used to provide the necessary stereo encoding as well as all the required audio processing such as gain adjustment, low pass filtering and pre-emphasis. In addition, the transmitter IC also generates the appropriate FM broadcast signal than can be tuned to any FM channel within the standard FM broadcast band (87.9 MHz to 107.9 MHz in the U.S.). In typical FM transmitter systems, this signal is normally connected to an antenna and broadcast to the car radio. However, in transmitter 22, this signal S1 is fed to the input of the 900 MHz FM transmitter 22C (also referred to as “upconverter”), viz., into a mixer that is configured as a 902-928 MHz upconverter such as the CEL UPC8172TB. This input signal S3, typically between 87.9 and 107.9 MHz is mixed with a fixed frequency local oscillator (LO) to generate an output that falls within the 902 MHz to 928 MHz ISM band. The upconverter 22C generates an output at a frequency which is both the sum and difference between the input frequency and the LO frequency. The LO is generated by a voltage controlled oscillator (VCO) 22E consisting of an RF transistor, resonator and varactor diode. The VCO is tuned and controlled by a Phase Lock Loop (PLL) 22F to form a frequency synthesizer. The LO is set to a fixed frequency, such as 815 MHz, by programming the PLL 22F using appropriate firmware in a microprocessor μP1 in the CPU power management & FM channel select 22F. The oscillator is designed to provide very low phase noise so as not to degrade the system signal-to-noise ratio (S/N) of the audio signal. In this unique upconversion process, frequency modulation occurs at the lower RF frequency (87.9 to 107.9 MHz) and not at the higher LO frequency which would further degrade the S/N ratio. The oscillator output is buffered by a high isolation amplifier (UPC8178TB) to minimize load pulling prior to being coupled into the upconverter 22C. The output of the upconverter 22C is passed through an amplifier buffer to provide the correct output level and then coupled to a 902-928 MHz bandpass (BPF) filter to select the sum frequency and reject both the difference frequency and other undesirable emissions. The BPF consists of a surface acoustic wave (SAW) filter but can also be implemented using discrete inductor-capacitor (LC) components. The filtered output is coupled to a fixed attenuator that provides additional isolation between the upconverter 22C and the antenna 22D. An attenuator is used to adjust the radiated output level to meet the emission requirements of the FCC, typically 1 mW or less. A ¼ wave monopole antenna is constructed from a strand of wire.

This design can be also be configured differently to shift the frequency tuning from the 100 MHz VCO to the 815 MHz VCO. In this approach, the 100 MHz VCO is changed from a tuned frequency to fixed frequency mode and correspondingly the 815 MHz VCO is changed from a fixed frequency to tuned frequency mode. This could be implemented with a simple firmware change. The choice of configurations would be based upon performance and the design complexity of the 815 MHz VCO.

In order for the user to tune the present invention to an “empty” or “clear” station on his vehicle's FM tuner, a user interface is provided with the transmitter 22, and is referred to as the “channel select” 22J. By way of example only, the minimal user interface comprises an LCD (e.g., FIG. 4C) to display frequency and tuning buttons (see FIG. 4B, “store”, “tune up” and “tune down”). The display indicates which FM channel the invention 20 is tuned to (this will match the frequency of the car radio). The tune up/down buttons are used to adjust the frequency. Typically, most devices also include a memory or preset button to allow the desired frequency to be stored in non-volatile memory. This channel select 22J is by way of example only since the end manufacturer will determine the display requirements and user interface and this may vary from design to design based upon cost and form factor.

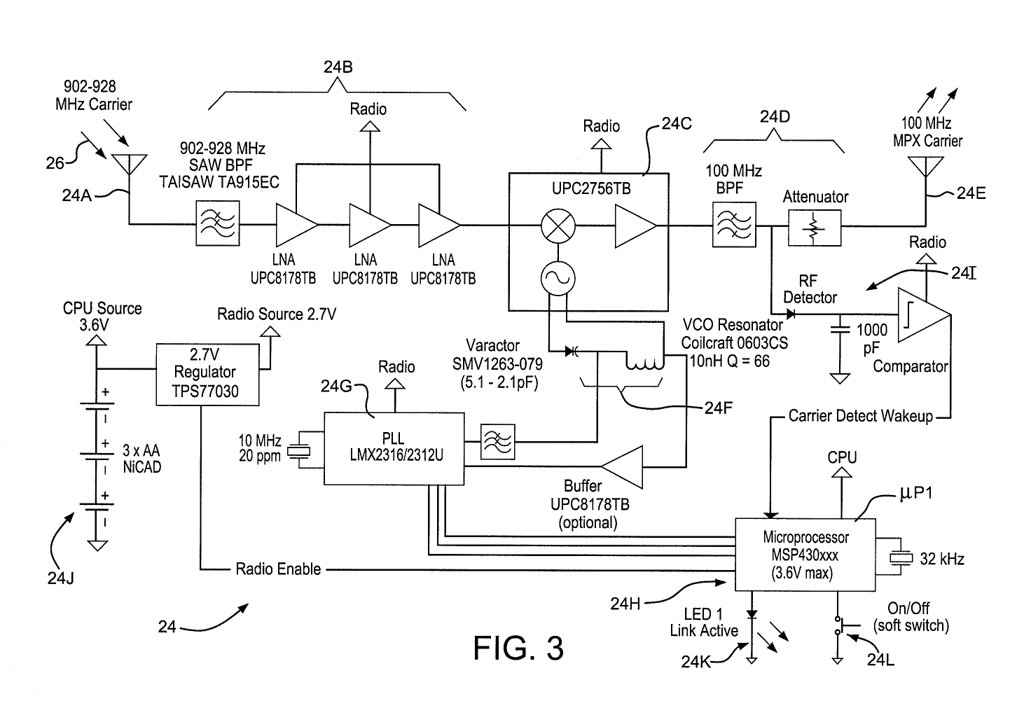

The transmitter 22 obtains its power from an external power source 8, typically 12VDC from the vehicle's battery via the lighter socket. Thus, the CPU power management & FM channel select 22F and power supply & spare battery charger 22H cooperate to manage this power input. In addition, a rechargeable battery pack 22I is installed in the transmitter 22 so as to provide a back-up power supply for the repeater 24 which is battery-powered (see 24J in FIGS. 1 and 3). Thus, when the battery 24J in the repeater 24 needs recharging, the recharged battery 22I is removed from the transmitter 22 and swapped out with the depleted battery in the repeater 24. The depleted battery 24J is then installed in 22I for recharging. As a result, there is always a back-up or recharged battery 22I in the transmitter 22 available for use in the repeater 24.

FIG. 2A is an alternate transmitter 22′ design approach. In particular, the MPX encoded baseband signal S2 in the MPX encoder 22B′ directly modulates the fixed frequency VCO 22E. In this approach, the 100 MHz VCO and upconversion mixer are eliminated and the fixed frequency VCO is converted from an 815 MHz offset frequency to the direct 915 MHz frequency (see 22C′ in FIG. 2A). Use of the alternate transmitter 22′ does not require any changes in the repeater 24 operation (discussed below). However, it should be noted that the transmitter 22 has several advantages over transmitter 22′. First, transmitter 22 takes full advantage of the low cost, fully-integrated single chip FM transmitter ICs. Second, it permits the design to be more easily retrofitted into existing 100 MHz FM transmitter products. Third, by modulating the 100 MHz VCO and keeping the 900 MHz VCO fixed and un-modulated, the overall audio performance of the system can be improved since the lower frequency VCO can provide better phase noise. On the other hand, transmitter 22′ could potentially provide a more cost effective solution. The MPX encoder 22B′ can be implemented with single-chip encoder, Rohm BA14xx series, or a higher performance discrete design.

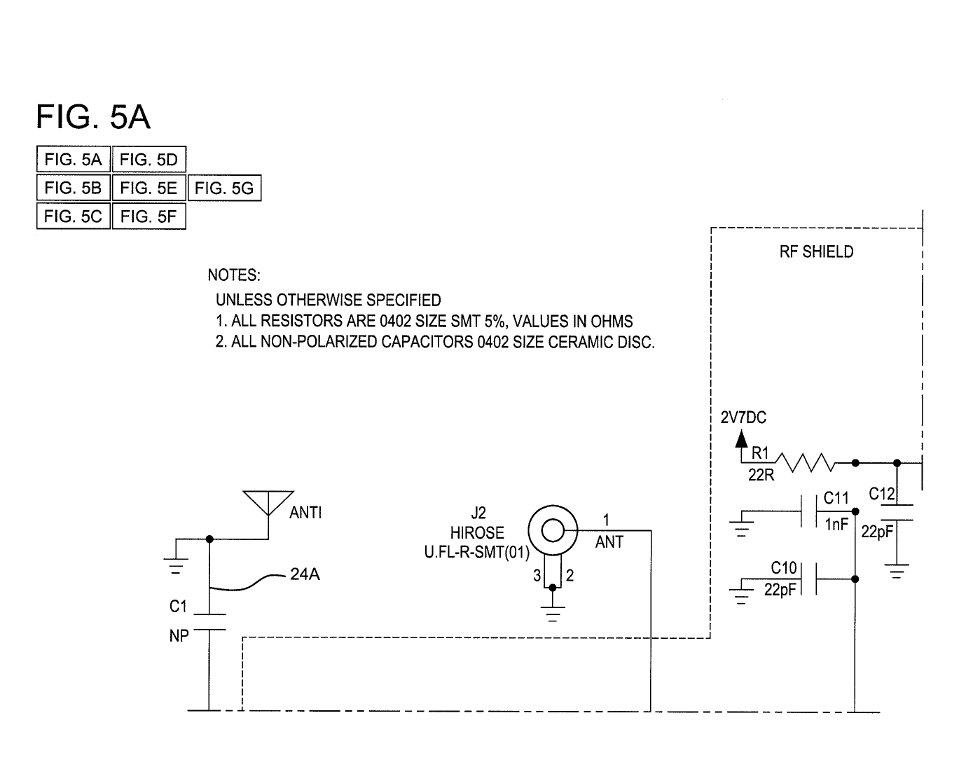

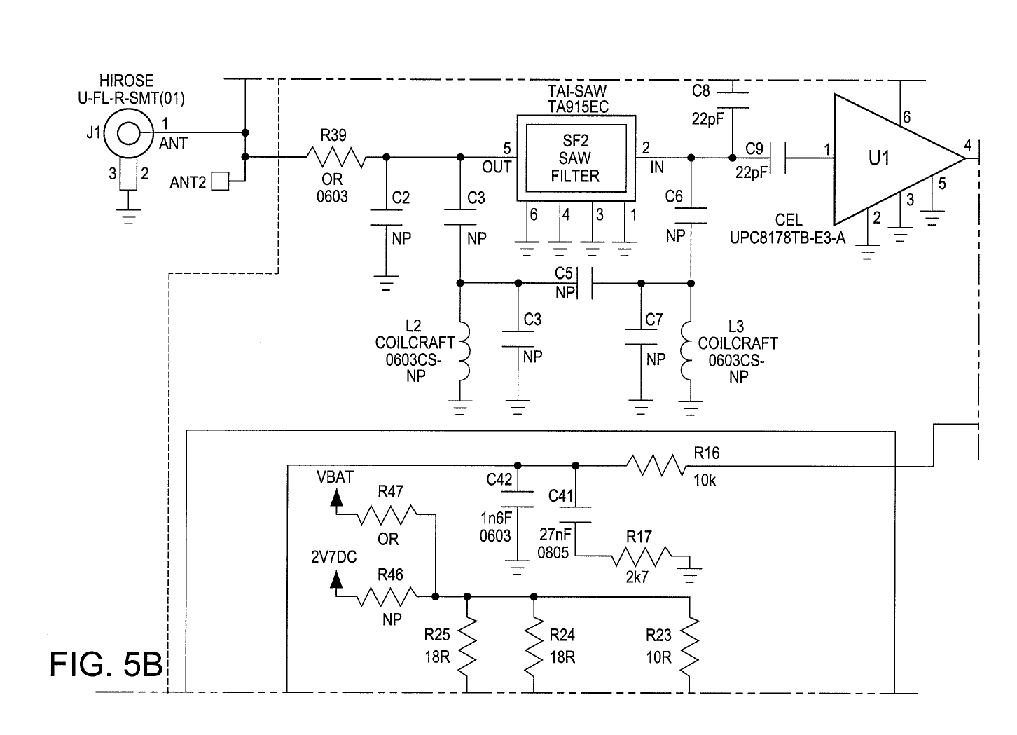

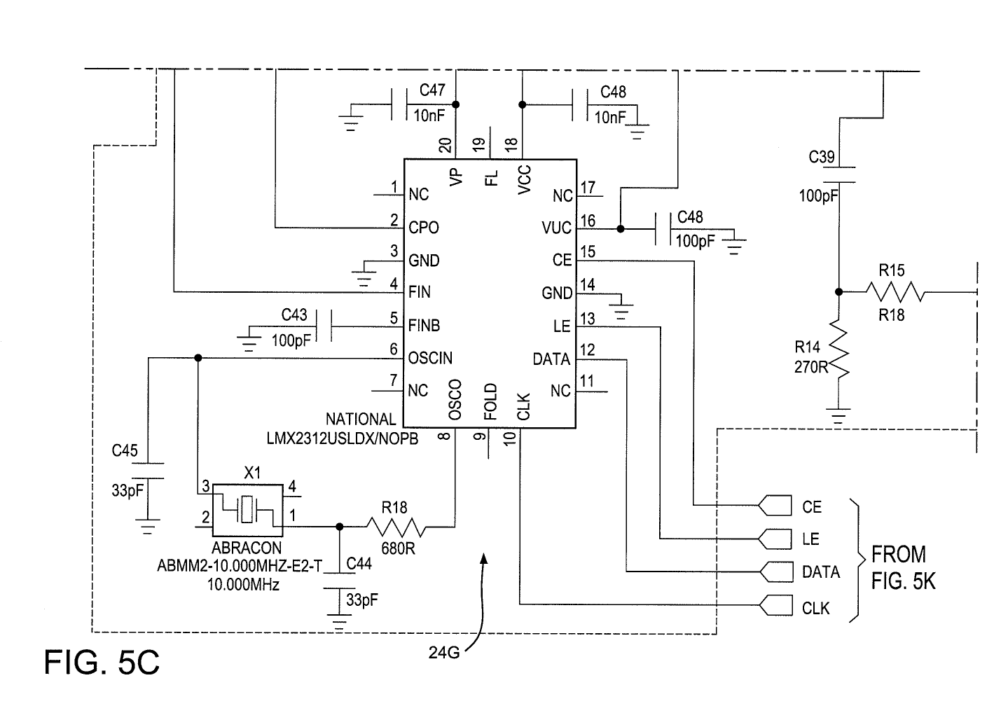

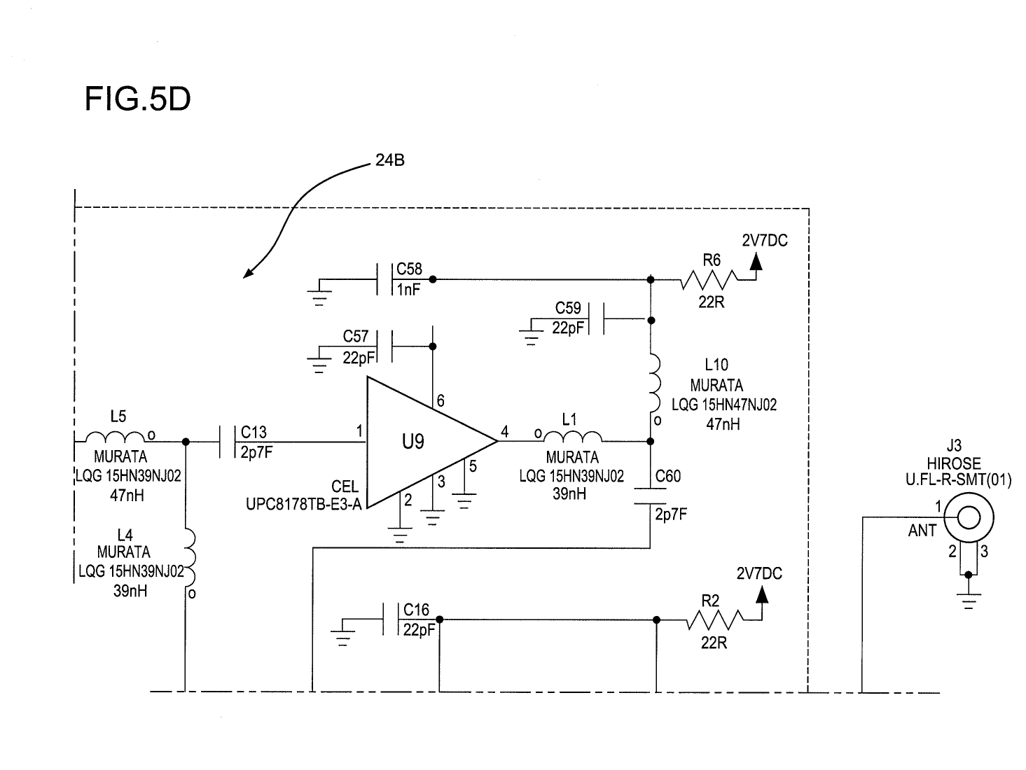

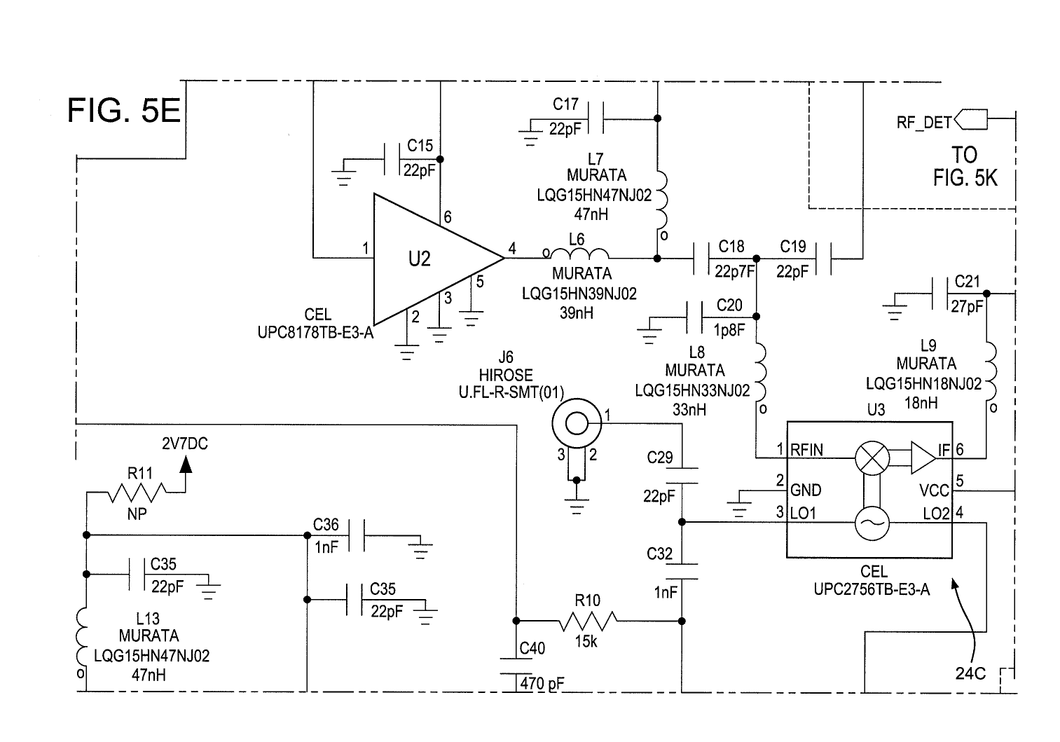

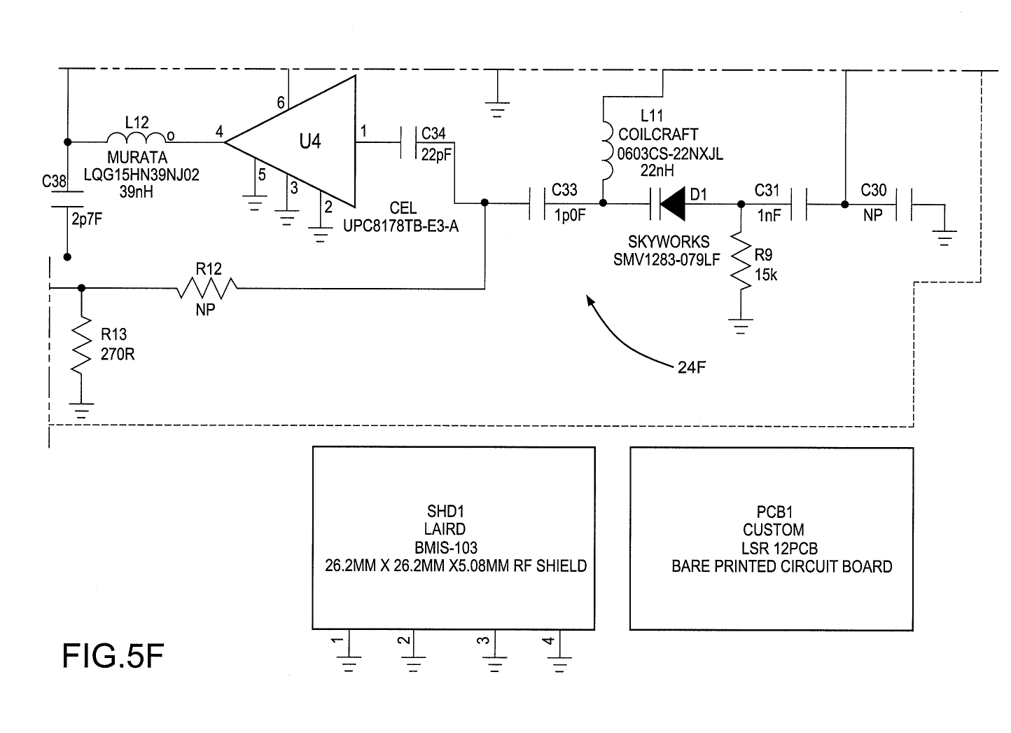

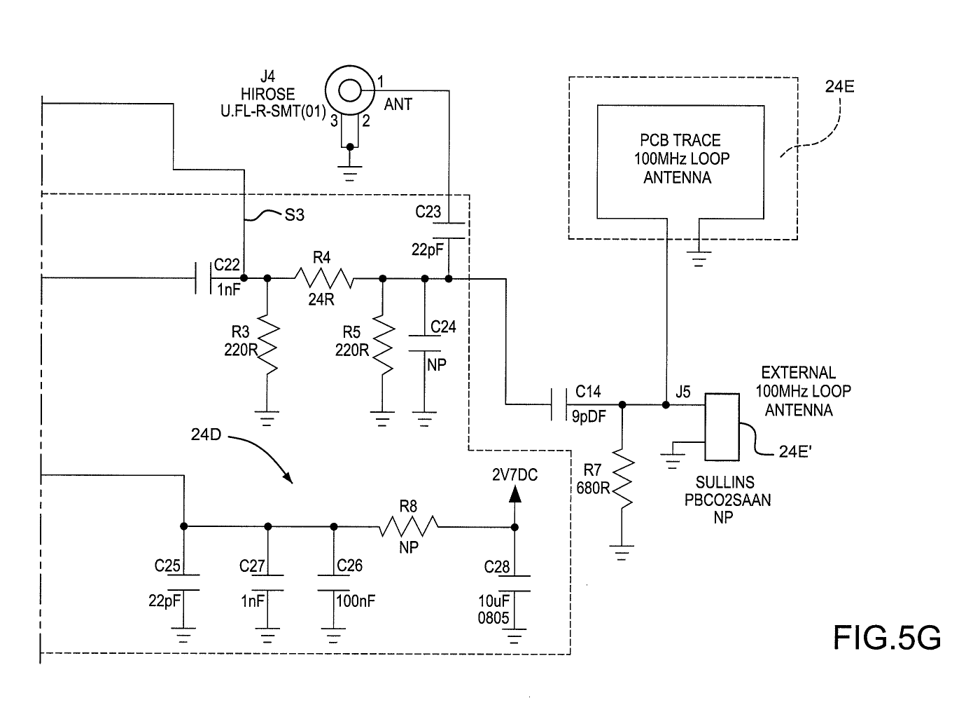

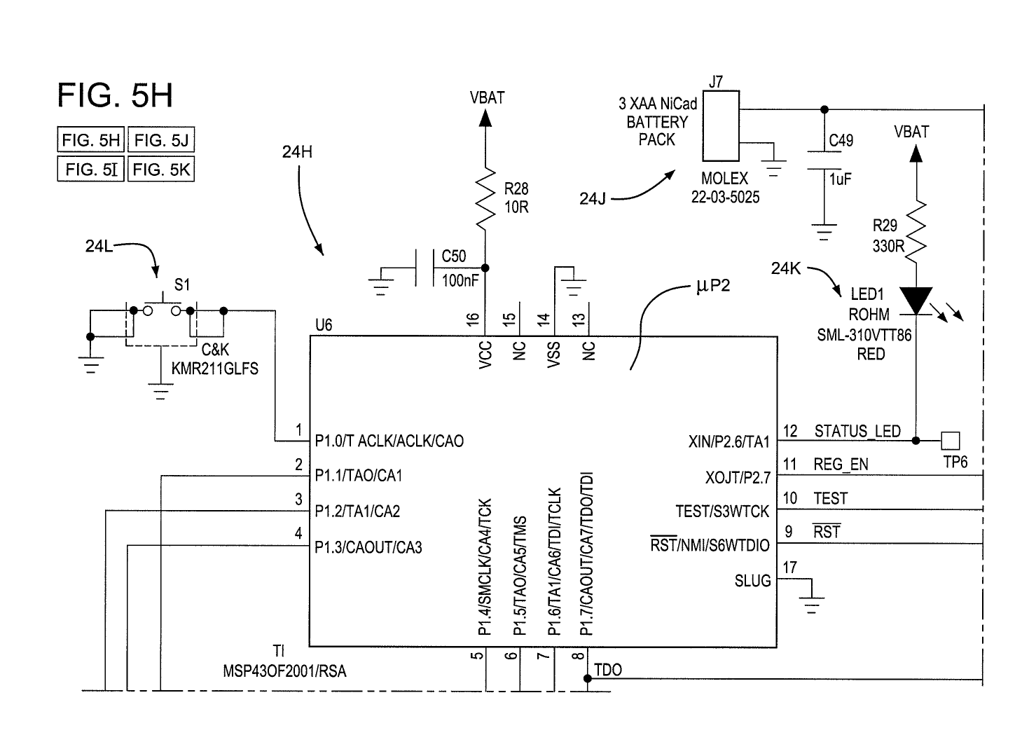

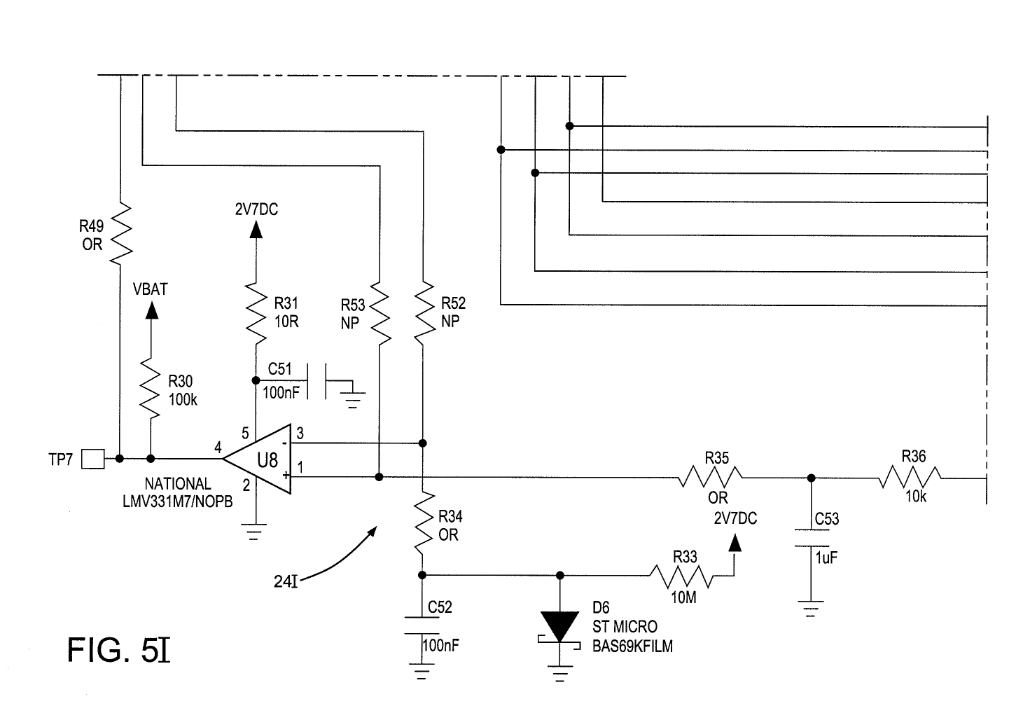

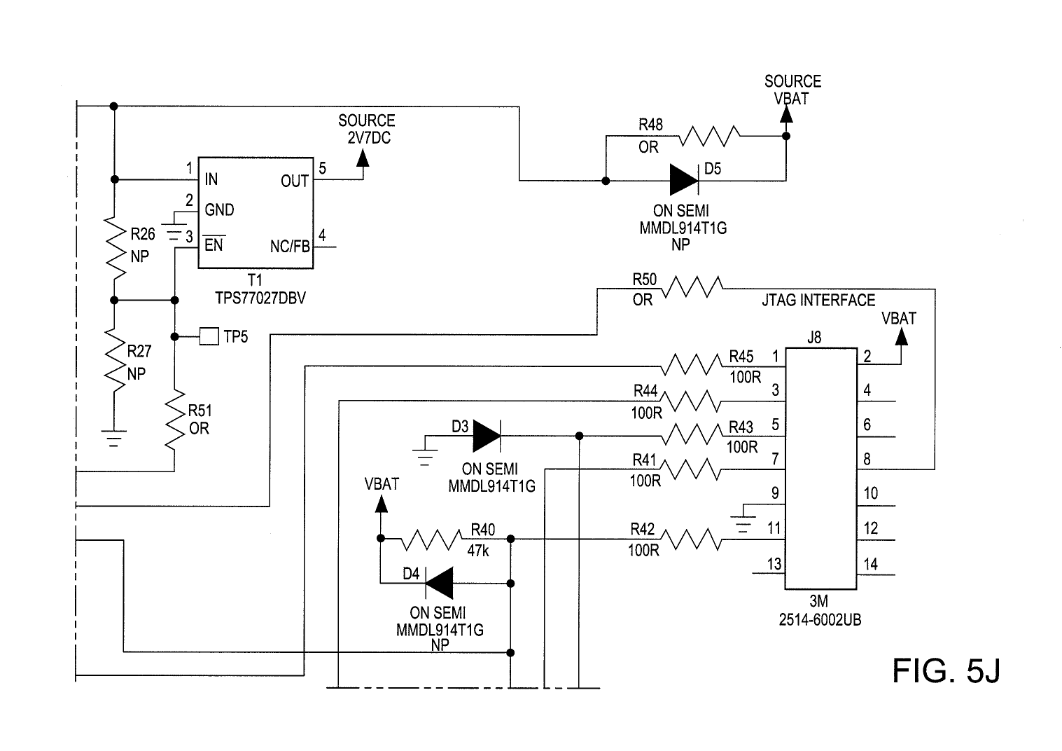

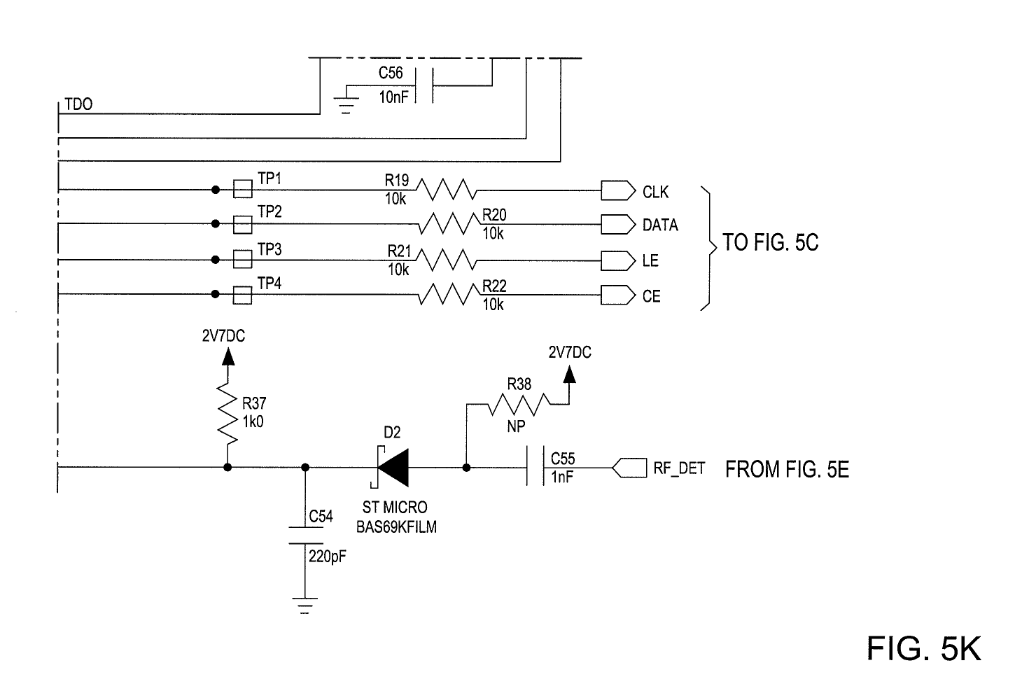

FIG. 3 is a block diagram of the repeater 24 and FIGS. 5A-5B are the corresponding schematics, by way of example only. The repeater 24 receives the incoming signal 26 in one specific frequency band (e.g., 902-928 MHz), downconverts, without demodulating, the received signal, and then transmits the signal 28 in a different frequency band (viz., the FM frequency band) at the same time. As a result, the term “repeater” as used in this Specification is slightly different from that used in the known art. In particular, whereas repeaters used in conventional wireless systems receive and then transmit a wireless signal on the same frequency, the repeater 24 receives the signal 26 on a first carrier frequency (e.g., 902-928 MHz) and transmits the signal 28 in a lower frequency band (e.g., the FM frequency band). It should also be noted that the terms “Radio” and “CPU” in FIGS. 3 and 5A-5B refer to the power “Radio Source 2.7V” and “CPU Source 3.6V”, respectively.

In particular, the repeater 24 operates as follows: the 902 MHz to 928 MHz RF carrier radiated by the transmitter 22 is received by the repeater antenna 24A. The ¼ wave monopole antenna 24A is fabricated from a strand of wire. In order to reduce size, the antenna 24A can also be integrated onto a PCB using a planar inverted-F configuration (PIFA); see also 24E′ in FIG. 5A. The RF signal 26 is received by the 900 MHz receiver function 24B, and in particular, this comprises passing the signal 26 through a preselector or bandpass filter consisting of a SAW filter to eliminate interference of out-of-band signals. To reduce cost, the filter can also be implemented using discrete components. Next, the signal is amplified by three cascaded low noise amplifiers (UPC8178TB) before being applied to the RF input of the 900 MHz-to-FM downconverter 24C (UPC2756TB). The downconverter 24C functions as a mixer and generates an output that contains both the sum and difference of the RF and LO frequencies. The LO frequency is generated by a fixed frequency VCO 24F using an on-chip oscillator of the UPC2756TB and an external resonator (0603CS inductor) and varactor diode (SMV1236-079). The VCO 24F is tuned and controlled by a Phase Lock Loop (PLL) 24G to form a frequency synthesizer. The LO is set to a fixed frequency such as 815 MHz via programming the PLL with appropriate firmware in the microprocessor μP2 in the CPU power management & FM channel select 24H. The oscillator is designed to provide very low phase noise so as not to degrade the system signal-to-noise ratio (S/N) of the audio signal. In this unique downconversion process, it is not necessary to demodulate the RF signal, which would further degrade the audio performance, before converting it to the 87.9 to 107.9 MHz band carrier.

The output of the downconverter 24C is passed to the FM band transmitter 24D which comprises a 100 MHz bandpass filter to select the mixer output difference frequency and reject the sum frequency and other unwanted spurious frequencies such as the LO. The bandpass filter consists of a discrete LC circuit. The output of the BPF is then passed through a fixed attenuator and connected to the 100 MHz antenna 24E. Although the RF output power of the repeater 24 is proportional to the input power of the received signal 26, the output is also limited so as not to exceed the FCC radiated emission limits. The low noise amplifier (see 24B) and upconverter ICs (24C) were specifically chosen with very low output level compression points. The natural limiting effect of the mixer compression (24C), when combined with a fixed attenuator (24D) and antenna 24E with well-controlled gain characteristics assure that a radiated output power at or near the FCC limit is maintained regardless of the location of the transmitter 22 and received signal strength.

The 100 MHz antenna 24E is a unique electrically small, magnetic field, loop antenna. This antenna topology was selected to provide a well-controlled and uniform radiated electromagnetic field. This antenna topology provides consistent gain that allows the maximum radiated power to be realized regardless of device orientation and installation location. This topology also has a very small near field radiation pattern and is not easily detuned by the human body and other structures such as the vehicle. This allows the maximum FCC limit radiated emission level to be realized and maintained. Alternatively, an external antenna 24E′ (FIG. 5A) may be used for the repeater 24 which also operates to provide a well-controlled and uniform radiated electromagnetic field.

The output S3 (FIG. 5A) of the downconverter 24C is also fed into the RF detector 24I which is used to detect the presence of a signal from the transmitter 22. As shown in FIG. 5B, the RF detector 24I is implemented with a pair of Schottky diodes, to from an envelope detector and an ultra-low current comparator. The RF detector 24I is used to form a carrier detect wake up signal. To reduce average current consumption and prolong battery lifetime, the microprocessor μP2 power manages the entire repeater 24. In normal operation, the microprocessor μP2 wakes up the repeater 24 and samples the carrier detect output of the RF detector 24I. If no presence is detected, the repeater 24 is turned off to minimize current consumption. If a carrier is detected, the repeater 24 remains on and the device 24 operates normally. If desired, a unique ID code can be embedded into the transmission from the transmitter 22 using amplitude shift keying (ASK) modulation to allow selective decoding and wakeup of the repeater 24. The RF detector 24I is capable of decoding an ASK signal and forwarding the ID code to the microprocessor μP2. The RF detector 24I is also used as an automatic turn on/off circuit for the repeater 24. Since the repeater 24 is normally located near the vehicle antenna, it would be impractical and inconvenient to require the device to be manually turned on when the device 24 is used, especially while the vehicle is being driven. The RF detector 24I automatically turns on the repeater 24 once the transmitter 22 is activated and also automatically turns the repeater 24 off a few minutes after transmissions from the transmitter 22 cease.

An indicator 24K (e.g., LED, as shown in FIGS. 3 and 5B) flashes indicating that the link has been established, viz., that the system 20 is running. In addition, the indicator 24K can also be used to assist in positioning the repeater 24 for maximum signal reception. Furthermore, the indicator 24K can serve as a low battery warning for the repeater. A switch 24L is also provided for turning off the repeater 24, and there by conserving battery power, where long-term non-use of the present invention occurs.

The output level radiated by the repeater antenna 24E is proportional to the input level (i.e., at the receiver antenna 24A) but limited so it does not exceed a predetermined power level, e.g., Part 15.209 General emission limit (43.52 dBuV/m) or a specific Part 15 intentional limit. Hence, the preselector (in the 900 MHz receiver function 24B) is included at the antenna input to limit response to only in-band.

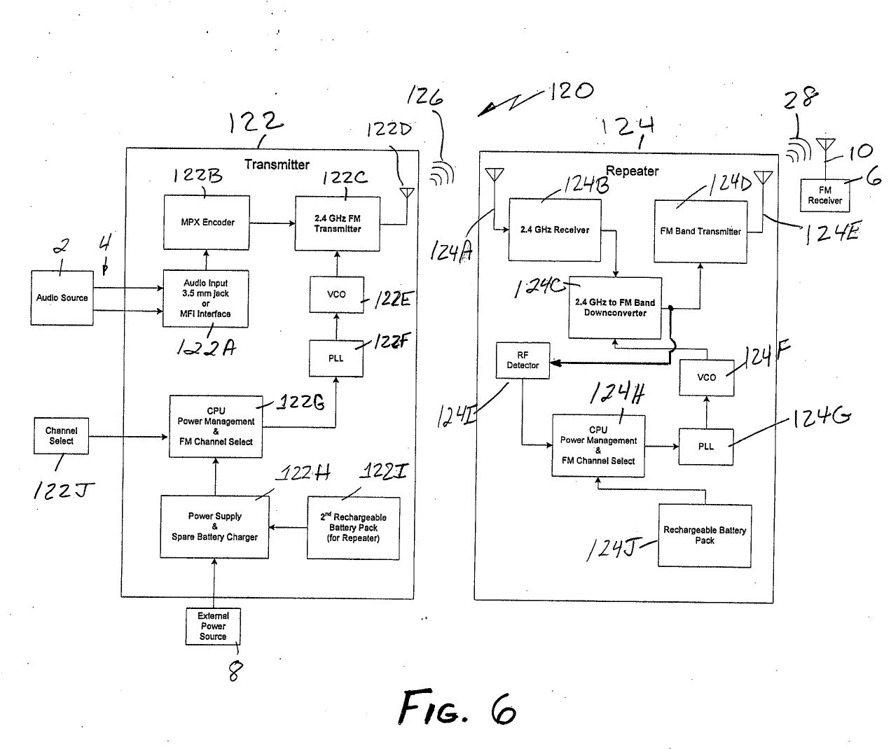

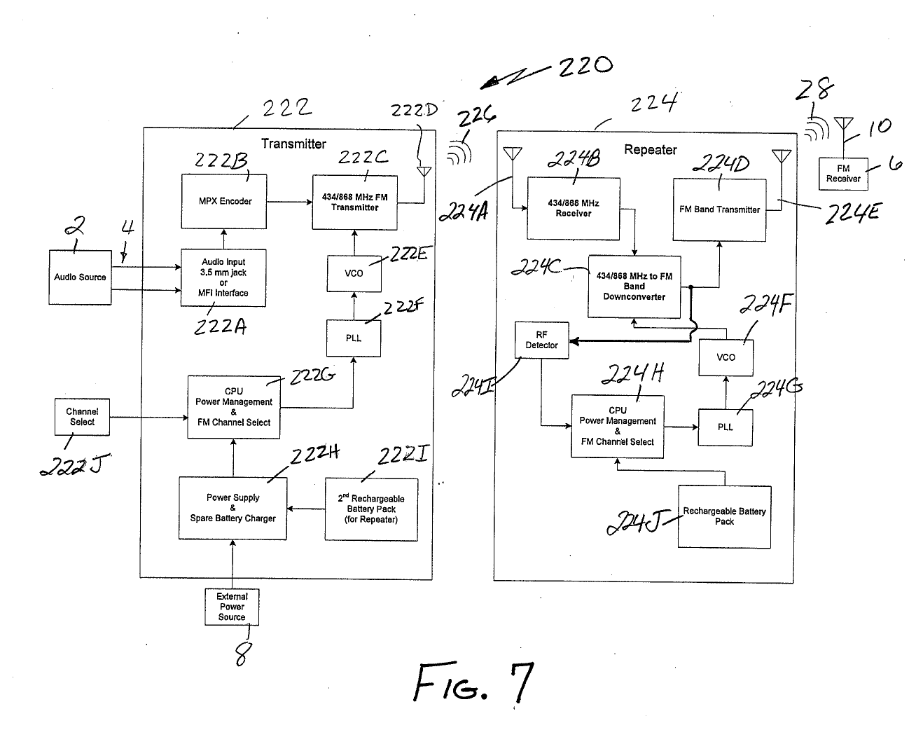

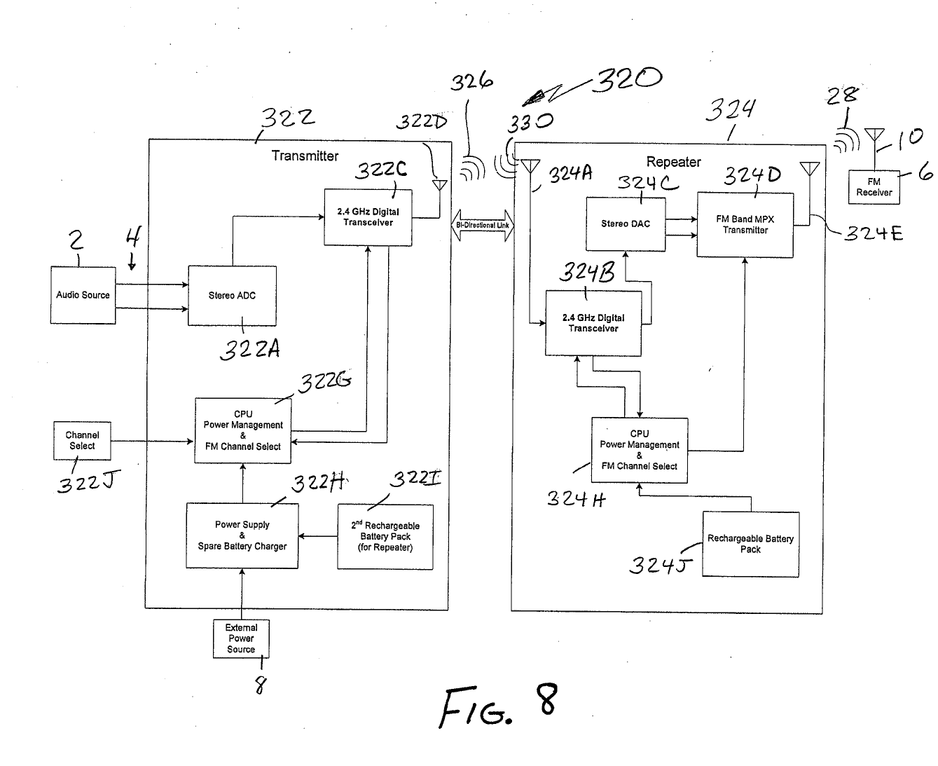

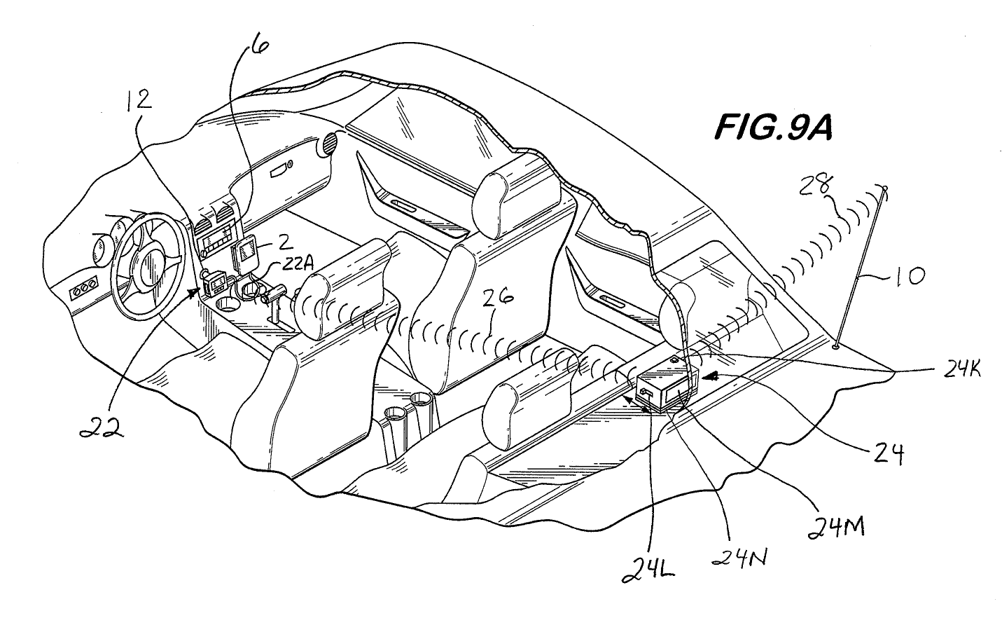

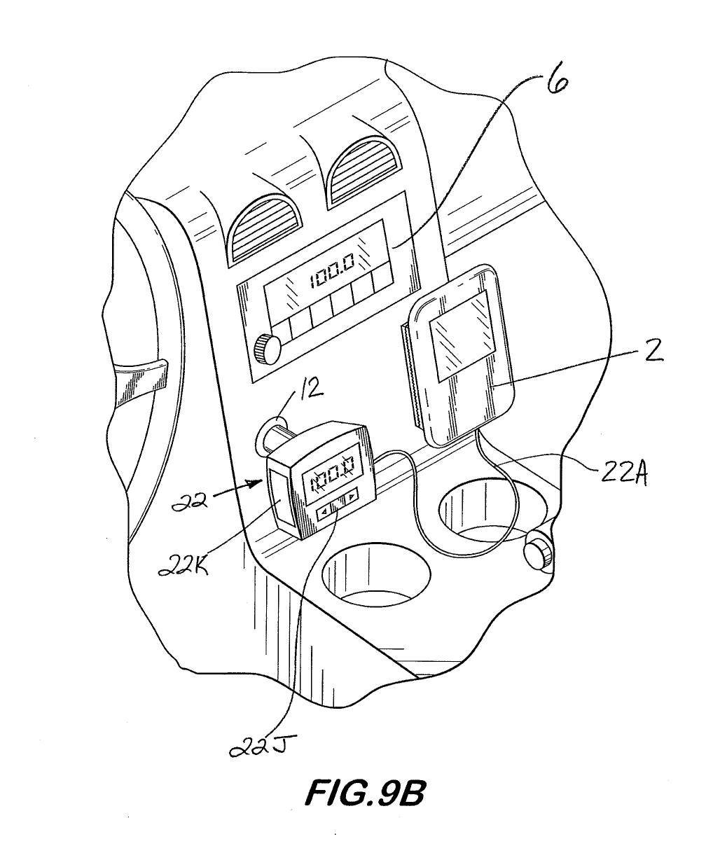

To use the present invention 20, the end user would do the following in accordance with FIGS. 9A-9B. With the vehicle in a safe location and parked, the user locates the repeater 24 10 inside the vehicle as close to the vehicle antenna 10 as possible. The user makes certain that the repeater switch 24L (FIG. 9A) is turned on. The transmitter 22 is then coupled to the vehicle power source 12, most likely using a lighter plug insert. The audio source 2 would then be coupled to the transmitter 22 using the audio interface 22A. The end user uses his car radio 6 to locate and select an unused FM channel (“empty” or “clear” channel) in the 87.9 MHz to 107.9 MHz FM broadcast band (e.g,: 100.0 MHz). Using the channel select 22J, the user sets the transmitter 22 to the same frequency (100.0 MHz) using the tune up/down buttons and the LCD display. Internally, this sets the VCO in the MPX encoder 22B (viz., the FM stereo radio with transmitter IC, e.g., TI SN76133) to 100 MHz. With the internal fixed VCO 22E set to 815 MHz, the upconverter output frequency is 915 MHz and this is then broadcast by the transmitter 22. The repeater 24 is continually waking up and looking for a valid signal via the RF detector 24I. Once a valid signal is received, the repeater 24I remains awake. The received 915 MHz signal 26 is then mixed with the repeater's internal fixed VCO's 815 MHz carrier and the resulting output at 100 MHz is then re-radiated from the repeater 24 to the car radio. The user can adjust the position of the repeater 24 within the vehicle to obtain a better link or coupling to the vehicle antenna 10; in fact, the user can use the indicator 24K (FIG. 9A) to see if a steady indication is present to provide an optimum coupling. Once that optimum location is found, releasable securement means 24N (FIG. 9A, e.g., adhesives, suction cups, hook and pile patches, etc.) provided with the repeater 24 may be used to secure the repeater 24 at that location. Once the system 20 is installed, the user does not need any further access to the repeater 24. If for any reason the user needs to select a different FM channel on his car radio (e.g., on a long trip where the clear stations on the FM band may change at different cities or regions), the end user simply selects a different FM channel on his car radio and also adjusts the transmitter 22 to the same frequency; the remainder of the system 20 automatically adjusts and the repeater 24 generates the correct output frequency. This allows the present invention 20 design to operate on all channels in the FM band with the minimal amount of adjustments and tuning.

It should be noted that the reference number 22K (FIG. 9B) on the transmitter 22 represents a cover for the recharger; thus, when a depleted battery pack from the repeater 24, needs to be recharged, the cover 22K is removed and the depleted battery pack inserted into the transmitter 22 for recharge by the recharger 22I. Reference number 24M (FIG. 9A) on the repeater 24 represents the battery pack compartment or a solar cell. Thus, where a battery pack is used, upon its depletion, the cover 24M is removed and the depleted battery pack inserted into the recharger 22I of the transmitter 22. Alternatively, where the repeater 24 uses a solar cell 24M, the repeater 24 takes advantage of its long term exposure to sunlight for power.

The link between the transmitter 22 and the repeater 24 is operational within a range of approximately 3 meters.

FIG. 6 depicts an alternative version 120 of the present invention wherein operation of the transmitter portion 122 operates in the 2.4-2.483 GHz (e.g., in the U.S. and other world-wide operation). In particular, the transmitter 122 comprises an audio input 122A (3.5 mm jack or MFI interface), an MPX encoder 122B, a 2.4 GHz FM transmitter 122C, an antenna 122D, a VCO 122E, a PLL 122F, a CPU power management & FM channel select 122G, a power supply & spare battery charger 122H, a second rechargeable battery pack 122I (as back-up for use in the repeater 124) and a channel select 122J. The repeater 124 comprises a receive antenna 124A, a 2.4 GHz receiver 124B, a 2.4 GHz-to-FM band downconverter 124C, an FM band transmitter 124D, a transmit antenna 124E, a VCO 124F, a PLL 124G, a CPU power management & FM channel select 124H, an RF detector 124I and an internal power supply 124J (e.g., a rechargeable battery pack). The transmitter 122 transmits a high frequency stereo encoded signal 126 (viz., in the 2.4-2.483 GHz frequency band) while the repeater 124, again without demodulating, transmits the signal 28 in the FM broadcast band. As discussed previously, both the transmitter 122 and especially the repeater 124, operate in accordance with government regulations on such wireless transmission levels.

FIG. 7 depicts another alternative version 220 of the present invention that complies with wireless operation in European countries. In particular, the transmitter 222 comprises an audio input 222A (3.5 mm jack or MFI interface), an MPX encoder 222B, a 434/868 MHz FM transmitter 222C, an antenna 222D, a VCO 222E, a PLL 222F, a CPU power management & FM channel select 222G, a power supply & spare battery charger 222H, a second rechargeable battery pack 222I (as back-up for use in the repeater 224) and a channel select 222J. The repeater 224 comprises a receive antenna 224A, a 434/868 MHz receiver 224B, a 434/868 MHz-to-FM band downconverter 224C, an FM band transmitter 224D, a transmit antenna 224E, a VCO 224F, a PLL 224G, a CPU power management & FM channel select 224H, an RF detector 224I and an internal power supply 224J (e.g., a rechargeable battery pack). The transmitter 222 transmits a high frequency stereo encoded signal 126 (viz., in the 434/868 MHz frequency band) while the repeater 224, again without demodulating, transmits the signal 28 in the FM broadcast band. As discussed previously, both the transmitter 222 and especially the repeater 224, operate in accordance with government regulations on such wireless transmission levels.

FIG. 8 illustrates a version of the present invention 320 design that utilizes a wireless digital audio link (instead of analog FM) comprising a transmitter 322 having a transmit antenna 322D and a repeater 324 having a receive antenna 324A and a transmit antenna 324E. In this application, the audio is digitized and broadcast over a wireless digital transceiver. This may be based upon an industry standard such as Bluetooth or a proprietary link such as the KLR3012 transceiver from Kleer. This application requires a transceiver or bidirectional link since in order to stream continuous digital audio, packet error correction and acknowledgements are required. The bi-directional link also provides the ability to control the repeater from the transmitter (e.g., FM channel selection, low battery monitoring, etc.). In this application, the analog audio output 4 is digitized by a stereo analog-to-digital convertor 322A, formed into digital packets and modulated onto a RF carrier using a digital receiver 322C and using one of the common digital modulation techniques such as FSK, GFSK or OFDM. The RF carrier can be either 900 MHz or 2.4 GHz where digital transmission is allowed by the appropriate regulatory agency (e.g., FCC in the U.S.); thus, although FIG. 8 shows a “2.4 GHz” digital transmitter and receiver, a 900 MHz digital receiver is also implied therein. This would include frequency hopping and any other form of Digital Transmission Systems (DTS).

The digital receiver 324B in the repeater 324 receives and decodes the digital audio transmission and uses a stereo digital-to-analog converter 324C to reproduce the original right and left channel audio signals. It should be noted that in many instances the ADC and DAC are integrated into the digital transceiver chips. A single chip FM transmitter with embedded MPX encoder 324D, such as the TI SN761634, is used to develop the standard stereo FM broadcast signal that is coupled to the car radio via the antenna. This digital audio transceiver version provides a similar solution by utilizing a high frequency wireless link to allow the FM transmitter antenna 322D to be remotely located near the vehicle antenna.

It should be noted that similar to the previous embodiments, the transmitter 322 also comprises a CPU power management & FM channel select 322G, a power supply & spare battery charger 322H, a second rechargeable battery pack 322I (as back-up for use in the repeater 224) and a channel select 322J. And, as with the previous embodiments, the repeater 324 also comprises a CPU power management & FM channel select 324H and an internal power supply 324J (e.g., a rechargeable battery pack). Because of the bidirectional link, where acknowledgements or other communication signals 330 are present, an equivalent function to the RF detector in the previous repeater embodiments is not needed.

An extension of this embodiment 320 and which is within the broadest aspect of the present invention is the use of a cell phone that communicates directly with the repeater 324. In particular, the transmitter 322 is replaced with a cell phone that is modified for communication with the repeater 324. With many Bluetooth® technology providers (e.g., CSR of the United Kingdom) embedding FM stereo transmitters in their next generation Bluetooth® chips for cell phones (many of which already incorporate Bluetooth® functionality for hands-free vehicle operation, as well as integrated MP3 players), it is within the broadest scope of the invention 320 to encompass a modified cell phone for communication directly with the repeater 324. Thus, the term “transmitter” as used with regard to the device that transmits to the repeater 324, is to be construed to include such a modified cell phone.

Where satellite radio is not provided as part of the vehicle's radio system, a user can purchase a satellite radio receiver that includes a transmitter (SR transmitter) for providing a wireless transmission to the vehicle's radio antenna. However, as mentioned previously, many of these SR transmitters are in violation of government regulations on wireless transmission levels, and the performance of these devices are of questionable quality. To comply with the government regulations and provide good quality audio, the baseband of the satellite receiver (SR) output can be diverted from the SR transmitter and coupled to the invention (20-320) of the present application, as indicated by the audio source 2 in the figures. FIG. 10 discloses another embodiment 422 wherein instead of coupling the SR output into the transmitter 22 (or 122-322), the satellite receiver 422 incorporates the transmitter portion 22 of the system 20 therein. In particular, the satellite radio signal 4A is received by the conventional satellite radio receiver antenna 15 and processed by the receiver's electronics 16. The baseband is then fed to the transmitter 22 and processed as discussed previously. It should be understood that various components, e.g., channel select 22J, the μP1, etc., may already exist as part of the receiver's electronics 16 in which case the transmitter 22 can be integrated to use those existing components. This integrated satellite receiver 422 can be modified for use with any of the frequency band configurations (e.g., 2.4-2.483 GHz, 434/868 MHz, etc.) discussed previously.

It should be noted that the key features of the foregoing embodiments of the present invention, or additional modifications that can included therein, are discussed below (the reference number 22 and 24 are by way of example only and are available for any of the previous embodiments discussed above):

Scanning Receiver Option: Many existing FM transmitter products also incorporate a scanning receiver feature. This feature incorporates a FM band receiver which automatically scans the FM band and determines the best clear channel. This feature eliminates the need for the end user to manually tune his car radio to determine the clearest channel. To implement this feature in the transmitter 22, the single chip transmitter IC, such as the TI SN761634 is replaced with a similar chip that also contains an FM receiver, such as the TI SN761631.

Auto Tuning Repeater: One advantage of the present invention is that it is not necessary to tune the repeater 24. By adjusting the output frequency of the transmitter 22, the output frequency of the repeater 24 can be controlled. Although not literally considered an “auto-tuning device” but it essentially functions as one. This is a very useful feature since the repeater 24 would typically be remotely located and out of reach by the driver thereby making it nearly impossible to adjust. It is a commonly known fact that the FM radio reception varies as a vehicle is driven and thus it may be necessary for the end user to select a “new” clear FM channel on an as needed basis. The present invention provides a strong coupling of the signal to the car antenna and thereby reduces the need to search for a new clear channel. And where channel changes are required by the user, the present invention facilitates this by not having to adjust the repeater 24.

Ultra-Low Current Consumption by repeater 24: As mentioned previously, a key feature of the present invention is that the repeater 24 circuit topology does not require a full receiver and transmitter to receive the 900 MHz carrier and convert it to an equivalent 100 MHz signal. This provides a significant reduction in overall current consumption and therefore the only topology that makes battery operation practical. It also provides another advantage in that it uses fairly small AAA or AA size batteries. This allows the repeater 24 form factor to be reduced making it more practical to mount to vehicle windows.

Dual Battery: the repeater batteries eventually become discharged. Using primary (i.e., disposable) batteries becomes costly since this product is typically used for many hours at a time. Rechargeable batteries are the preferred option but will also eventually need to be recharged. It is not convenient for the user to wait several hours to charge the batteries and most would not have a battery charger readily available in their vehicle. However, via the charger 22H there a second battery pack 22I is integrated into the transmitter 22. This allows for one battery pack to always be charged while the other is in use. A second advantage of having a rechargeable battery on board the transmitter 22 is that by adding a second voltage detection circuit, it is possible to allow the transmitter 22 to operate off the second battery 22I when it (i.e., the transmitter 22) is unplugged from the vehicle power source. This feature then transforms the present invention into a portable system that allows audio source to be played in the house with a home stereo system or in outdoor places such as parks, or a backyard, etc., with a boom box, etc.

Innovative FM Band Antenna (Repeater 24): The current embodiment of the repeater 24 uses a small loop antenna 24E that is integrated onto the PCB and fully contained within the repeater enclosure. This design permits the repeater 24 to be easily coupled to vehicle window antennas by placing the module directly on the window. As mentioned previously, the innovative repeater loop antenna provides a more consistent radiated output power when compared to the audio cable type antennas used by many of the competitive FM transmitters. It is also less susceptible to performance loss that can occur due to improper placement and loading by the metallic portions of the vehicle body. This method of coupling is typically described as inductive coupling or a magnetic field antenna (whereas most wire antennas are considered to be electrical field antennas).

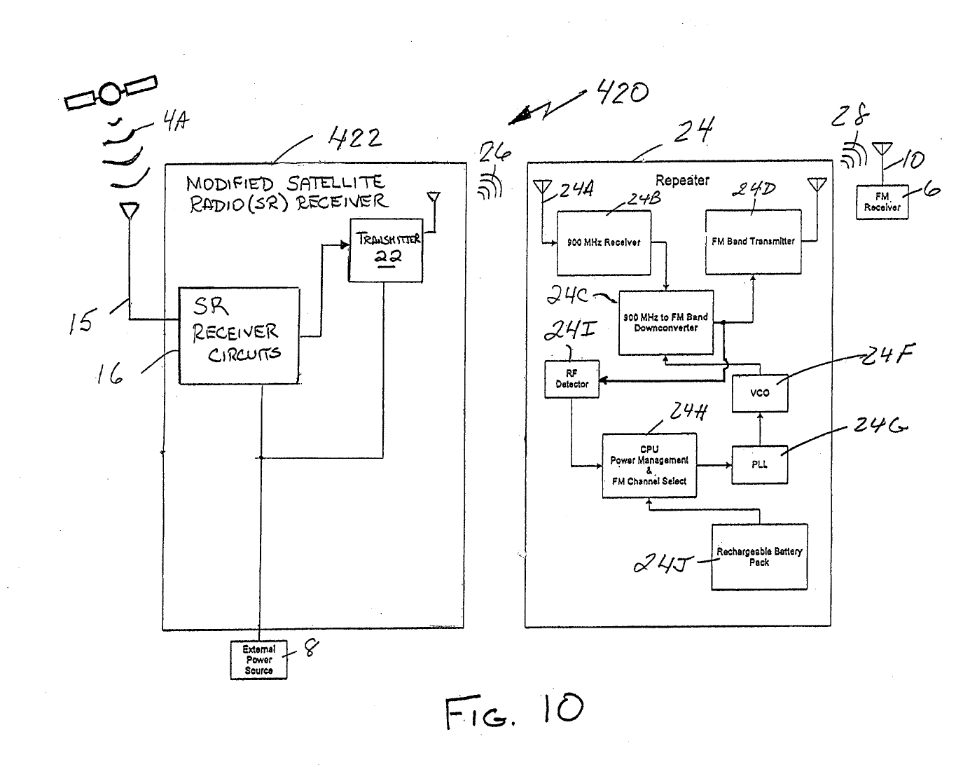

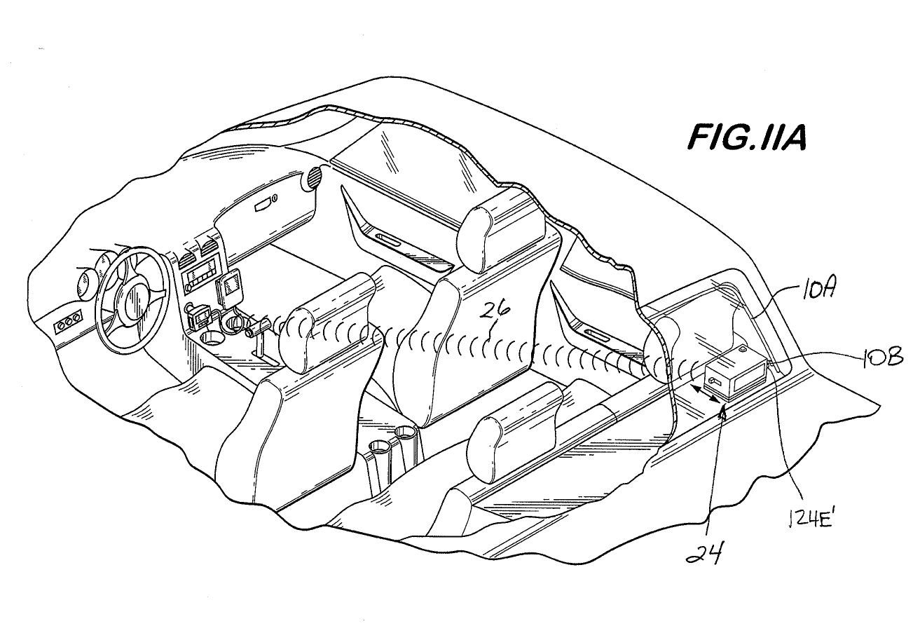

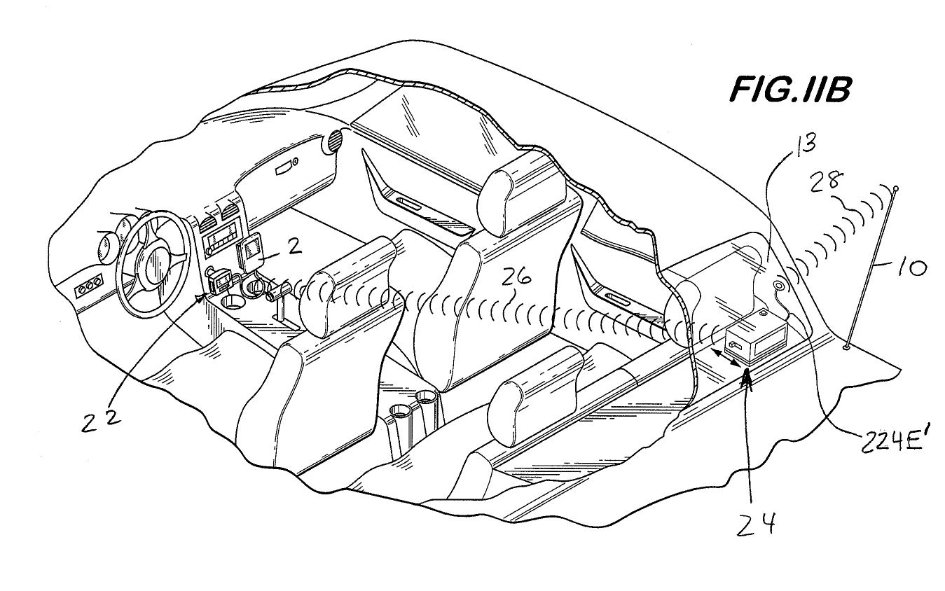

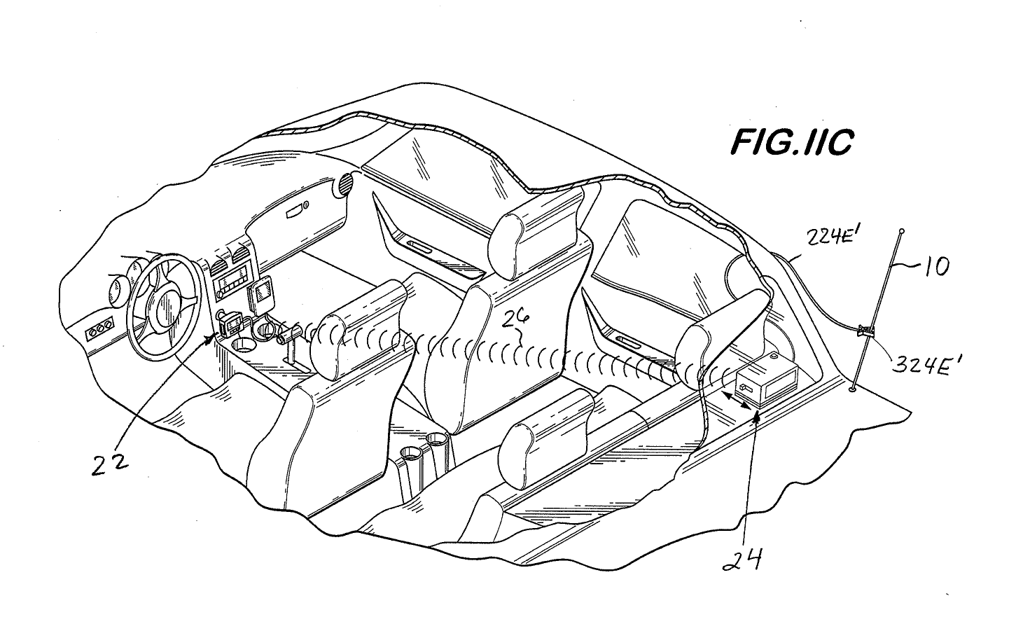

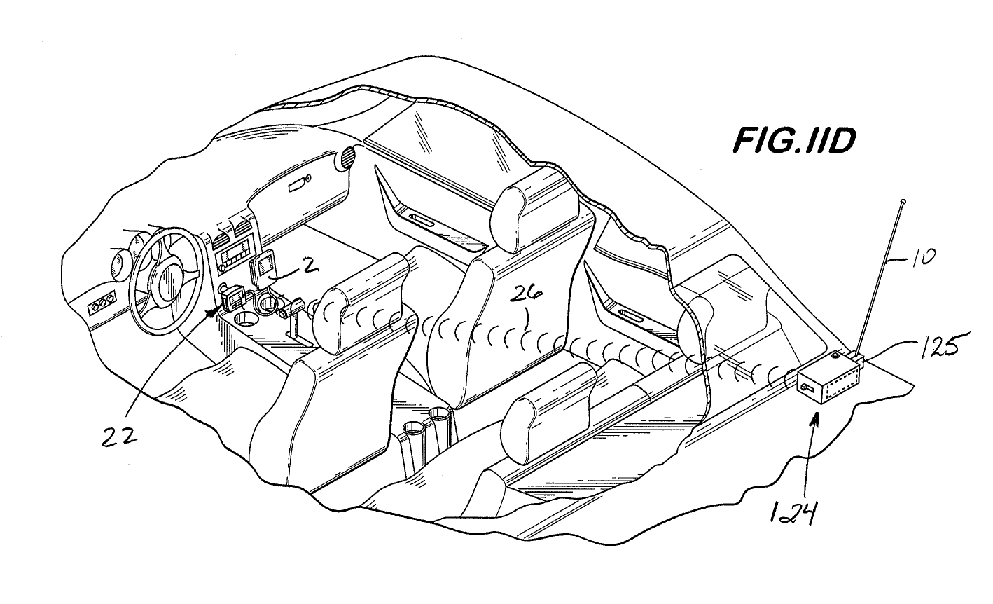

As shown in FIG. 11A, a higher degree of coupling can be provided if the loop antenna 24E′ is connected to an external contact or pad 124E′ on the outside surface of the repeater 24 that would physically come into contact with (e.g., touch), or be closely adjacent, the foil trace 10B of the windshield antenna 10A. This method of coupling is typically described as capacitive coupling.

Although the window antenna is the most common vehicle antenna other antenna variations exist. The most common are the front/rear fender whip antenna and the roof or window frame antenna. Since these two antenna types are located outside the vehicle, proper antenna coupling is more difficult due to the additional distance between the antenna and repeater. Since the degree of coupling between the repeater 24 and the vehicle antenna 10 directly influences overall performance, it is essential to locate the repeater antenna 24E as close to the vehicle antenna 10 as physically possible. The self-contained loop antenna 24E of the repeater 24 provides acceptable performance with external vehicle antennas 10. It is within the broadest scope of this invention to include different versions of the repeater 24 that utilize other antenna types. For example, as shown in FIG. 11B, one alternative uses a wire antenna 224E′ that extends from the repeater 24 and can be clipped to the vehicle window 13 in a location close to the vehicle antenna 10. This larger antenna 224E′ has a higher gain than the PCB loop antenna 24E and provides better coupling. Another alternative, shown in FIG. 11C, provides a clamp 324E′, rubber boot, clip or some other method of coupling the repeater signal 28 directly to the vehicle antenna 10 via the vehicle door or window. As shown in FIG. 11D, another alternative is to locate the repeater 24 outside the vehicle. In particular, the repeater 24 is repackaged into a weatherized/environmentally-rugged device 124 that couples (e.g., via a clamp 125) onto the base of the vehicle antenna 10.

Effective RF Limiter Maintains Field Strength at or below FCC Limit (Repeater 24) Without the Use of Conventional Limiters: a combination of a low noise amplifier/mixer configuration and loop antenna are used to maintain a constant radiated field strength at 100 MHz to assure that the repeater 24 always maintains compliance with the FCC emission limits. The amplifier/mixer circuit (see 24B and 24C in FIGS. 3 and 5A) eliminates variation in the 100 MHz output signal that is caused by normal variation in the received 900 MHz signal. An electrically small magnetic field loop antenna with resistive loading is a ground independent antenna that eliminates variations in antenna gain caused by device placement, orientation as well as loading effects of nearby metal structures such as the vehicle body. The unique combination of the amplifier/mixer configuration and loop antenna allows the repeater 24 to maintain consistent radiated field strength. This allows the device to operate at maximum field strength without exceeding the FCC emission limit. The gains of the amplifiers have been selected based on transmission signal levels within the interior of different vehicles. The scaling implemented in combination with the mixer in the downconverter of the repeater 24 permits the input signal power level to be effectively limited (e.g., saturating amplifier rails) while simultaneously downconverting the input signal to the FM frequency carrier band. No discrete limiters are used, which among other things, draws significant current. A well-controlled radiated output power provides a significant performance advantage over typical FM transmitter products where the manufacturer has one of two choices: the design can be adjusted to operate well under the FCC emission limit to assure that worst case emissions are still compliant but performance suffers, or the design can be adjusted to maximize performance and be subject to exceeding the FCC emission limit under a worst case condition.

Low Battery Alert: A low repeater battery audible alert is not unique as it is already implemented in various other products such as smoke detectors. However, as used in the present invention, the audio level of the alert (or beep) is designed to change with the volume level of the music, as indicator to the user of a repeater low battery condition. Due to the fact that the repeater 24 may be installed in a location that is not viewable from the driver's seat (see FIG. 9A), an audible alert is used to notify the user that the repeater batteries are becoming low. The alert, an audible beep or pulse, is implemented by either indirectly modulating the VCO 24F by changing the PLL 24G frequency or directly by modulating the VCO tuning voltage with a square wave from the microprocessor. Both methods are unique in the fact that it is not necessary to demodulate the MPX encoded signal to add the frequency modulated beep. In order for the low battery warning to be audible while music is played in the car, it is necessary to adjust the level of beep with respect to the music level. By inserting the beep signal in the repeater carrier, the beep level automatically changes as the user adjusts the volume level of the car radio. It should be noted that this implementation assumes that the user presets the volume level of the audio input device and then only adjusts the music level via the car radio. Some devices, such as iPod®s, provide a line level of fixed output to the transmitter. In addition, a low battery detection circuit may include a conventional battery voltage measurement which also includes a time-of-use metering technique that allows the microprocessor μP2 to predict when the battery would need to be charged based upon available battery capacity and operating hours between charges. Once the battery was placed in the charger, the timer is then reset.

Alternative Power Sources: Due to the ultra low power consumption of the repeater 24 design, the repeater electronics can operate using a low cost solar cell as the power source. In practice, a rechargeable battery would be used to provide a power source for the repeater 24 and the solar cell would be used to keep the battery charged or at least prolong the interval between normal charging cycles. The application of a solar powered source is ideally suited for in-vehicle use since repeater is typically mounted in a vehicle window and operated in sunlight.

Home Stereo Systems: Although the present invention is primarily intended for car radio systems, the repeater 24 can also be used to couple the audio input device to various other output devices that contain FM radios such as home stereo systems and boom boxes.

Unique Regulatory Classification: The highly efficient antenna coupler of the downconverter in the repeater 24 and low emission levels may significantly reduce the high costs of regulatory compliance testing if the device can be classified under general emission and not as an intentional transmitter (this classification is still pending).

It should be understood that the present invention 20 is not limited to MP3 players but can be used with any other type of portable hand-held audio device that use WAV, AIFF, AAC, FLAC, Vorbis, etc.

TABLE 1
Major Components of Transmitter 22

| Transmitter Component | Explanation |
|---|---|
| Audio Interface | Interface varies depending upon what the audio input device is. |
| | Typically, this is an audio cable with the appropriate connector |
| | that provides a connection to the audio output of the audio |
| | device 2. This may comprise a custom cable. By way of |
| | example, a generic MP3 Player comprises an audio cable with |
| | 3.5 mm headphone plug; Apple iPod ®'s and iPhone ™ use an |
| | audio cable with Apple connector. |
| Stereo MPX Encoder 22B: | TI SN76134 - Single-Chip FM Stereo Transmitter |
| | TI SN761633 - Single-Chip FM Stereo Transmitter & |
| | Receiver |
| | Rohm also has an extensive line of MPX ICs that can be used: |
| | BH14xx series (see also |
| | http://www.rohm.com/products/lsi/sound/wireless_audio_link/) |
| 900 MHz Upconverter | CEL UPC8172TB |
| RF Transistor | CEL NE85630 |
| 900 MHz Antenna | ¼ wave monopole |
| | ½ wave dipole |
| | Inverted-F PCB trace antenna |
| 3 V Power Supply-Linear | TI TPS77030DBV |
| Dropout Regulator - | |
| 5 V Power Supply - Linear | National Semiconductor - LM2992IM5-5.0 |
| Regulator - | |
| Battery Charger | TI BQ2002TSN charger, |
| | National LM1117 Constant Current Source |
| Display | custom LCD |
| | display driver IC - NXP OM8577DH |

TABLE 2
Major Components of Repeater 24

| Repeater Components | Explanation |
|---|---|
| 900 MHz Antenna | ¼ wave monopole |
| | ½ wave dipole |
| | Inverted-F PCB trace antenna |
| RF Preselector-SAW Bandpass Filter | TAI-SAW Part Number: TA915EC |
| discrete LC filter | |
| Low Current LNA - Low Noise Amplifier | CEL Part Number: UPC8178TB |
| RFIC | |
| MMIC Downconverter - mixer & oscillator | CEL Part Number: UPC2756TB |
| PLL Frequency Synthesizer - 1.2 GHz | National Semiconductor - LMX2312U |
| Varactor Diode - Voltage Controlled | Skyworks SMV1263-079LF |
| Oscillator | |
| Oscillator Resonator - Hi-Q Wire wound | Coilcraft 0603CS□30NXJL |
| Inductor | |
| RF Detector Diode - Low Capacitance Small | ST Micro-BAS69 |
| Signal Schottky Diode | |
| Comparator - single low voltage comparator | National Semiconductor - LMV331M7 |
| Voltage Regulator - ultra low-power low | TI-TPS77027 |
| dropout linear regulator | |
| Microcontroller - 16-bit mixed signal | TI-MSP430F2001 |
| microcontroller | |
| Reference Crystal - 10 MHz | Abracon ABBM2-10.000 MHz-E2□T |
| Battery Pack - 3 x AA Rechargeable | NiCad - 3.6 v, 1000 mA-H |
| | Panasonic custom assembly |
| | NiMH - 3.6 v, 2000 mA-H |
| | Panasonic custom assembly |
| 100 MHz Antenna | PCB trace loop antenna |
| | custom design based upon enclosure |

### Appendix

### §15.239 Operation in the Band 88-108 MHz.

(a) Emissions from the intentional radiator shall be confined within a band 200 kHz wide centered on the operating frequency. The 200 kHz band shall lie wholly within the frequency range of 88-108 MHz.
(b) The field strength of any emissions within the permitted 200 kHz band shall not exceed 250 microvolts/meter at 3 meters. The emission limit in this paragraph is based on measurement instrumentation employing an average detector. The provisions in §15.35 for limiting peak emissions apply.
(c) The field strength of any emissions radiated on any frequency outside of the specified 200 kHz band shall not exceed the general radiated emission limits in §15.209.
(d) A custom built telemetry intentional radiator operating in the frequency band of 88-108 MHz and used for experimentation by an educational institute need not be certified provided the device complies with the standards in this part and the educational institution notifies the Engineer in Charge of the local FCC office, in writing, in advance of operation, providing the following information:
   (1) The dates and places where the device will be operated;
   (2) The purpose for which the device will be used;
   (3) A description of the device, including the operating frequency, RF power output, and antenna; and,
   (4) A statement that the device complies with the technical provisions of this part.

### Historical Note

Subsection (d) corrected by erratum (DA 89-728) in Docket No. 87-389, released Jul. 7, 1989, 54 FR 32339.

§15.249 Operation within the Bands 902-928 MHz, 2400-2483.5 MHz, 5725-5875 MHz, and 24.0-24.25 GHz.
(a) Except as provided in paragraph (b) of this section, the field strength of emissions from intentional radiators operated within these frequency bands shall comply with the following:

| | | Field Strength | Field Strength |
|---|---|---|---|
| Fundamental | | of Fundamental | of Harmonics |
| Frequency | | (millivolts/meter) | (microvolts/meter) |
| 902-928 | MHz | 50 | 500 |
| 2400-2483.5 | MHz | 50 | 500 |
| 5725-5875 | MHz | 50 | 500 |
| 24.0-24.25 | GHz | 250 | 2500 |

(b) Fixed, point-to-point operation as referred to in this paragraph shall be limited to systems employing a fixed transmitter transmitting to a fixed remote location. Point-to-multipoint systems, omnidirectional applications, and multiple co-located intentional radiators transmitting the same information are not allowed. Fixed, point-to-point operation is permitted in the 24.05-24.25 GHz band subject to the following conditions:
   (1) The field strength of emissions in this band shall not exceed 2500 millivolts/meter.
   (2) The frequency tolerance of the carrier signal shall be maintained within ±0.001% of the operating frequency over a temperature variation of −20 degrees to +50 degrees C. at normal supply voltage, and for a variation in the primary supply voltage from 85% to 115% of the rated supply voltage at a temperature of 20 degrees C. For battery operated equipment, the equipment tests shall be performed using a new battery.
   (3) Antenna gain must be at least 33 dBi. Alternatively, the main lobe beamwidth must not exceed 3.5 degrees. The beamwidth limit shall apply to both the azimuth and elevation planes. At antenna gains over 33 dBi or beamwidths narrower than 3.5 degrees, power must be reduced to ensure that the field strength does not exceed 2500 millivolts/meter.
(c) Field strength limits are specified at a distance of 3 meters.
(d) Emissions radiated outside of the specified frequency bands, except for harmonics, shall be attenuated by at least 50 dB below the level of the fundamental or to the general radiated emission limits in §15.209, whichever is the lesser attenuation.
(e) As shown in §15.35(b), for frequencies above 1000 MHz, the field strength limits in paragraphs (a) and (b) of this section are based on average limits. However, the peak field strength of any emission shall not exceed the maximum permitted average limits specified above by more than 20 dB under any condition of modulation. For point-to-point operation under paragraph (b) of this section, the peak field strength shall not exceed 2500 millivolts/meter at 3 meters along the antenna azimuth.
(f) Parties considering the manufacture, importation, marketing or operation of equipment under this section should also note the requirement in §15.37(d).

### Historical Note

Section revised by order (FCC 01-357) in Docket No. 98-156, effective Feb. 13, 2002, 67 FR 1623. For Report see 25 CR 439.

Subsection (e) added by order in Docket No. 87-389, effective Jul. 20, 1990, 55 FR 25094. For Memorandum Opinion see 67 RR 2d 1269.

### §15.209 Radiated Emission Limits, General Requirements.

(a) Except as provided elsewhere in this subpart, the emissions from an intentional radiator shall not exceed the field strength levels specified in the following table:

| | | Measurement |
|---|---|---|
| Frequency | Field Strength | Distance |
| (MHz) | (microvolts/meter) | (meters) |
| 0.009-0.490 | 2400 F (kHz) | 300 |
| 0.490-1.705 | 24000 F (kHz) | 30 |
| 1.705-30.0 | 30 | 30 |
| 30-88 | 100¹ | 3 |
| 88-216 | 150² | 3 |
| 216-960 | 200³ | 3 |
| Above 960 | 500 | 3 |

(b) In the emission table above, the tighter limit applies at the band edges.
(c) The level of any unwanted emissions from an intentional radiator operating under these general provisions shall not exceed the level of the fundamental emission. For intentional radiators which operate under the provisions of other sections within this part and which are required to reduce their unwanted emissions to the limits specified in this table, the limits in this table are based on the frequency of the unwanted emission and not the fundamental frequency. However, the level of any unwanted emissions shall not exceed the level of the fundamental frequency.
(d) The emission limits shown in the above table are based on measurements employing a CISPR quasi-peak detector except for the frequency bands 9-90 kHz, 110-490 kHz and above 1000 MHz. Radiated emission limits in these three bands are based on measurements employing an average detector.
(e) The provisions in §§15.31, 15.33, and 15.35 for measuring emissions at distances other than the distances specified in the above table, determining the frequency range over which radiated emissions are to be measured, and limiting peak emissions apply to all devices operated under this part.
(f) In accordance with §15.33(a), in some cases the emissions from an intentional radiator must be measured to beyond the tenth harmonic of the highest fundamental frequency designed to be emitted by the intentional radiator because of the incorporation of a digital device. If measurements above the tenth harmonic are so required, the radiated emissions above the tenth harmonic shall comply with the general radiated emission limits applicable to the incorporated digital device, as shown in §15.109 and as based on the frequency of the emission being measured, or, except for emissions contained in the restricted frequency bands shown in §15.205, the limit on spurious emissions specified for the intentional radiator, whichever is the higher limit. Emissions which must be measured above the tenth harmonic of the highest fundamental frequency designed to be emitted by the intentional radiator and which fall within the restricted bands shall comply with the general radiated emission limits in §15.109 that are applicable to the incorporated digital device.
(g) Perimeter protection systems may operate in the 54-72 MHz and 76-88 MHz bands under the provisions of this section. The use of such perimeter protection systems is limited to industrial, business and commercial applications.

Historical Note
Footnote to table in subsection (a) corrected by erratum (DA 89-728) in Docket No. 87-389, released Jul. 7, 1989, 54 FR 32339.
Subsection (g) revised by order in Docket No. 87-389, effective May 2, 1990, 55 FR 18339. For Memorandum Opinion see 67 RR 2d 928.
Subsection (g) revised by order in Docket No. 95-177, effective Dec. 1, 1997, 62 FR 58656. For Report see 9 CR 1240.

### End Notes

1. Except as provided in paragraph (g) of this section, fundamental emissions from intentional radiators operating under this section shall not be located in the frequency bands 54-72 MHz, 76-88 MHz, 174-216 MHz or 470-806 MHz. However, operation within these frequency bands is permitted under other sections of this part, e.g., §§15.231 and 15.241.
2. Except as provided in paragraph (g) of this section, fundamental emissions from intentional radiators operating under this section shall not be located in the frequency bands 54-72 MHz, 76-88 MHz, 174-216 MHz or 470-806 MHz. However, operation within these frequency bands is permitted under other sections of this part, e.g., §§15.231 and 15.241.
3. Except as provided in paragraph (g) of this section, fundamental emissions from intentional radiators operating under this section shall not be located in the frequency bands 54-72 MHz, 76-88 MHz, 174-216 MHz or 470-806 MHz. However, operation within these frequency bands is permitted under other sections of this part, e.g., §§15.231 and 15.241.

While the invention has been described in detail and with reference to specific examples thereof, it will be apparent to one skilled in the art that various changes and modifications can be made therein without departing from the spirit and scope thereof.

1. A wireless FM repeater system for converting an audio signal from a portable audio source and transmitting it to a vehicle's FM tuner having an FM tuner antenna where the FM tuner lacks an input jack for coupling to the portable audio source, said system comprising:
a transmitter, coupled to the audio source, for using a first frequency carrier signal comprising the audio signal to transmit a first transmitted signal, said transmitter comprising a channel select that permits a user to provide said transmitter with an FM frequency channel setting to which the vehicle's FM tuner is tuned; and
a self-powered repeater that receives said first transmitted signal and downconverts said first transmitted signal, without demodulating said first transmitted signal, to an FM frequency band carrier signal, said repeater transmitting said FM frequency band carrier signal to form a second transmitted signal, said second transmitted signal being transmitted from a repeater antenna and received by the vehicle's FM tuner antenna.

2. The wireless FM repeater system of claim 1 wherein said system self-limits an output level of said second transmitted signal for compliance with wireless transmission regulatory standards.

3. The wireless FM repeater system of claim 1 wherein said transmitter comprises an encoder and an upconverter, said encoder using said FM frequency channel setting to generate a FM frequency band signal, corresponding to said FM frequency channel setting, modulated with said audio signal, and wherein said upconverter upconverts said modulated FM frequency band signal to said first frequency carrier signal.

4. The wireless FM repeater system of claim 3 wherein said first frequency carrier signal is in the 902-928 MHz frequency band.

5. The wireless FM repeater system of claim 3 wherein said system self-limits an output level of said first transmitted signal for compliance with wireless transmission regulatory standards.

6. The wireless FM repeater system of claim 3 wherein said first frequency carrier signal is in the 2.4-2.483 GHz frequency band.

7. The wireless FM repeater system of claim 1 wherein said transmitter comprises an encoder and an upconverter, said encoder modulating an FM frequency band signal with said audio signal, said upconverter being tunable by said FM frequency channel setting and wherein said upconverter upconverts said modulated FM frequency band signal to said first frequency carrier signal.

8. The wireless FM repeater system of claim 7 wherein said first frequency carrier signal is in the 902-928 MHz frequency band.

9. The wireless FM repeater system of claim 7 wherein system self-limits an output level of said first transmitted signal for compliance with wireless transmission regulatory standards.

10. The wireless FM repeater system of claim 7 wherein said first frequency carrier signal is in the 2.4-2.483 GHz frequency band.

11. The wireless FM repeater system of claim 1 wherein said transmitter comprises a modulator that is tunable by said FM frequency channel setting, said modulator generating said first frequency carrier signal that is modulated with said audio signal.

12. The wireless FM repeater system of claim 11 wherein said first frequency carrier signal is in the 902-928 MHz frequency band.

13. The wireless FM repeater system of claim 11 wherein said system self-limits an output level of said first transmitted signal for compliance with wireless transmission regulatory standards.

14. The wireless FM repeater system of claim 11 wherein said first frequency carrier signal is in the 2.4-2.483 GHz frequency band.

15. The wireless FM repeater system of claim 1 wherein said transmitter comprises a battery recharger for recharging a depleted battery for use in said repeater.

16. The wireless FM repeater system of claim 1 wherein said repeater comprises a carrier signal detector for waking up said repeater.

17. The wireless FM repeater system of claim 1 wherein said repeater comprises a solar cell.

18. The wireless FM repeater system of claim 1 wherein the portable audio source comprises a satellite radio receiver.

19. The wireless FM repeater system of claim 1 wherein said transmitter coupled to the audio source comprises a satellite radio receiver.

20. The wireless FM repeater system of claim 1 wherein said repeater uses a battery and wherein said repeater comprises means for inserting an audible low battery alert into said FM frequency band carrier signal.

21. The wireless FM repeater system of claim 20 wherein said means for inserting comprises a voltage-controlled oscillator having a tuning voltage that is modulated by a square wave.

22. The wireless FM repeater system of claim 20 wherein said means for inserting comprises a voltage-controlled oscillator tuned and controlled by a phase lock loop, said phase lock loop generating a frequency that is modulated by a square wave.

23. The wireless FM repeater system of claim 20 wherein said means for inserting comprises a microprocessor coupled to a low battery detection circuit, said microprocessor predicting when a battery that is rechargeable needs recharging based on a battery capacity and time between charges of the battery.

24. The wireless FM repeater system of claim 1 wherein said repeater comprises an enclosure and said repeater antenna is contained within said enclosure.

25. The wireless FM repeater system of claim 1 wherein said repeater comprises an enclosure and wherein said repeater antenna comprises a portion that resides on an outside surface of said enclosure that forms a capacitive coupling with the vehicle antenna.

26. The wireless FM repeater system of claim 1 said repeater comprises an enclosure and wherein repeater antenna comprises a wire having a free end that can be positioned in close proximity to the vehicle antenna.

27. The wireless FM repeater system of claim 1 said repeater comprises an enclosure that couples to a base of the vehicle antenna.

28. The wireless FM repeater system of claim 2 wherein said repeater comprises an amplifier and mixer configuration that maintains constant output power for said second transmitted signal despite variations in said first transmitted signal and without the use of discrete limiters.

29. A method for receiving an audio signal from a portable audio source on a vehicle's FM tuner having an FM tuner antenna wherein the FM tuner lacks an input jack for coupling to the portable audio source, said method comprising:
inputting to a transmitter an FM frequency channel setting that corresponds to a channel to which the vehicle's FM tuner is tuned;
generating a first frequency carrier signal including the audio signal therein, provided from the audio source to said transmitter, and transmitting said first frequency carrier signal to form a first transmitted signal;
receiving, by a self-powered repeater, said first transmitted signal and downconverting it, without demodulating it, to an FM frequency band carrier signal;
transmitting, from a repeater antenna, said FM frequency band carrier signal to form a second transmitted signal; and
receiving said second transmitted signal by the vehicle's FM tuner antenna.

30. The method of claim 29 wherein said step of generating a first frequency carrier signal comprises:
modulating an FM frequency band carrier signal with said audio signal based on said FM frequency channel setting; and
upconverting said modulated FM frequency band carrier signal to said first frequency carrier signal.

31. The method of claim 29 wherein said method self-limits an output level of said second transmitted signal for compliance with wireless transmission regulatory standards.

32. The method of claim 29 wherein said step of transmitting from a repeater antenna comprises placing said repeater closely adjacent the vehicle's FM tuner antenna.

33. The method of claim 29 wherein said first frequency carrier signal is in the 902-928 MHz frequency band.

34. The method of claim 29 wherein said method self-limits an output level of said first transmitted signal for compliance with wireless transmission regulatory standards.

35. The method of claim 29 wherein said first frequency carrier signal is in the 2.4-2.483 GHz frequency band.

36. The method of claim 29 wherein said step of generating a first frequency carrier signal comprises:
modulating an FM frequency band carrier signal with said audio signal; and
tuning an upconverter using said FM frequency channel setting to upconvert said modulated FM frequency band carrier signal to said first frequency carrier signal.

37. The method of claim 36 wherein said first frequency carrier signal is in the 902-928 MHz frequency band.

38. The method of claim 36 wherein said method self-limits an output level of said first transmitted signal for compliance with wireless transmission regulatory standards.

39. The method of claim 36 wherein said first frequency carrier signal is in the 2.4-2.483 GHz frequency band.

40. The method of claim 29 wherein said step of receiving said first transmitted signal comprises detecting a carrier signal for waking up said self-powered repeater.

41. The method of claim 29 wherein said repeater uses a battery and further comprising the step of injecting an audible low battery alert into said FM frequency band carrier signal.

42. The method of claim 41 wherein step of injecting an audible low battery alert comprises changing an audio level of said audible low battery alert in accordance with a volume level change in the audio signal.

43. The method of claim 29 wherein said repeater uses a battery and further comprising the step of predicting when the battery requires recharging based on a battery capacity and a time between charging of the battery.

44. The method of claim 29 wherein said steps of transmitting and receiving said second transmitted signal comprises capacitively coupling said repeater antenna with the vehicle's FM tuner antenna.

45. The method of claim 29 wherein said steps of transmitting and receiving said second transmitted signal comprises inductively coupling said repeater antenna with the vehicle's FM tuner antenna.

46. The method of claim 29 wherein said steps of transmitting and receiving said second transmitted signal comprises physically coupling said repeater antenna with said vehicle's FM tuner antenna.

47. The method of claim 31 wherein said method comprises maintaining a consistent radiated field strength from said repeater antenna, independent of variations in said first transmitted signal without using discrete limiters.

48. The method of claim 29 wherein said method uses a satellite receiver output for the audio signal.

49. A wireless FM repeater system for converting an audio signal from a portable audio source and transmitting it to a vehicle's FM tuner having an FM tuner antenna where the FM tuner lacks an input jack for coupling to the portable audio source, said system comprising:
a digital transceiver, coupled to the audio source, for digitizing the audio signal and digitally modulating a first frequency carrier signal with said digitized audio signal to form continuous digital audio that is streamed over a bi-directional link with a self-powered repeater, said transmitter comprising a channel select that permits a user to provide said transceiver with an FM frequency channel setting to which the vehicle's FM tuner is tuned; and
said repeater receiving said continuous digital audio and decoding said continuous digital audio, said repeater converting said decoded continuous digital audio into analog audio signals, said repeater comprising an FM frequency band transmitter which modulates an FM frequency band carrier signal with said audio signals to form an FM band transmitted signal that is transmitted by a repeater antenna and that is received by the FM tuner antenna.

50. The wireless FM repeater system of claim 49 wherein said system self-limits an output level of said second transmitted signal for compliance with wireless transmission regulatory standards.

51. The wireless FM repeater system of claim 49 wherein said first frequency carrier signal is in the 902-928 MHz frequency band.

52. The wireless FM repeater system of claim 49 wherein said system self-limits an output level of said first transmitted signal for compliance with wireless transmission regulatory standards.

53. The wireless FM repeater system of claim 49 wherein said first frequency carrier signal is in the 2.4-2.483 GHz frequency band.

54. The wireless FM repeater system of claim 49 wherein said digital transceiver coupled to the audio source comprises a cell phone.

55. The wireless FM repeater system of claim 49 wherein said transmitter comprises a battery recharger for recharging a depleted battery for use by in said repeater.

56. A method for receiving an audio signal from a portable audio source on a vehicle's FM tuner having an FM tuner antenna wherein the FM tuner lacks an input jack for coupling to the portable audio source, said method comprising:
inputting to a digital transceiver an FM frequency channel setting that corresponds to a channel to which the vehicle's FM tuner is tuned;
digitizing the audio signal, provided from the audio source to said digital transceiver, to form a digitized audio signal;
digitally modulating a first frequency carrier signal with said digitized audio signal that is continuously streamed over a bi-directional link with a repeater;
receiving said continuously streaming digital audio, by said repeater, and decoding said streaming digital audio into decoded continuous digital audio;
converting said decoded continuous digital audio into analog audio signals;
modulating an FM frequency band carrier signal with said analog audio signals to form an FM frequency band signal that is transmitted from a repeater antenna to the FM tuner antenna.

57. The method of claim 56 wherein said method self-limits an output level of said second transmitted signal for compliance with wireless transmission regulatory standards.

58. The method of claim 56 wherein said step of receiving said continuously streaming digital audio comprises placing said repeater closely adjacent the vehicle's FM tuner antenna and wherein said repeater is self-powered.

59. The method of claim 56 wherein said first frequency carrier signal is in the 902-928 MHz frequency band.

60. The method of claim 56 wherein said method self-limits an output level of said first transmitted signal for compliance with wireless transmission regulatory standards.

61. The method of claim 56 wherein said first frequency carrier signal is in the 2.4-2.483 GHz frequency band.
